(19) United States
(12) Patent Application Publication
(10) Pub. No.: US 2019/0260240 A1
(43) Pub. Date: Aug. 22, 2019

(54) OPERATION METHOD OF WIRELESS POWER RECEIVER AND OPERATION METHOD OF WIRELESS POWER TRANSMITTER

(71) Applicant: LG INNOTEK CO., LTD., Seoul (KR)

(72) Inventors: YONG IL KWON, Seoul (KR); DONG HAN YOO, Seoul (KR); JAE KYU LEE, Seoul (KR)

(73) Assignee: LG INNOTEK CO., LTD., Seoul (KR)

(21) Appl. No.: 16/307,805

(22) PCT Filed: Jun. 2, 2017
(86) PCT No.: PCT/KR2017/005795

§ 371 Date: Dec. 6, 2018

(30) Foreign Application Priority Data
Jun. 7, 2016 (KR) 10-2016-0070467

(51) Int. Cl. H02J 50/80; H02J 5/00; H02J 7/02; H02J 50/12; H04B 5/00

(52) U.S. Cl. CPC H02J 50/80; H02J 5/005; H04B 5/0037; H02J 50/12; H02J 7/025

(57) ABSTRACT

An operation method of a wireless power receiver supporting an electromagnetic resonance mode and an electromagnetic induction mode according to an embodiment of the present invention may comprise the steps of: determining whether switching of a power transmission mode is necessary during wireless charging according to an electromagnetic induction mode; when switching of the power transmission mode is necessary, requesting a wireless power transmitter to switch the power transmission mode, by using extended charging termination information; and receiving power in a power transmission mode determined according to whether a connection has been established with the wireless power transmitter according to the electromagnetic resonance mode.

### TECHNICAL FIELD

Embodiments relate to wireless charging technology, and more particularly, to an operation method of a wireless power receiver and an operation method of a wireless power transmitter, for wirelessly transmitting power in an electromagnetic resonance mode and an electromagnetic induction mode.

### BACKGROUND ART

A portable terminal such as a cellular phone and a laptop computer includes a battery for storing power and a circuit for charging and discharging the battery. To charge the battery of such a terminal, the terminal needs to receive power from an external charger.

In general, an example of an electrical connection mode between a battery and a charging device for charging the battery with power includes a terminal supply mode of receiving commercial power, converting the commercial power into voltage and current corresponding to the battery, and supplying electrical energy to the battery through a terminal of the corresponding battery. The terminal supply mode is accompanied by use of a physical cable or wiring. Accordingly, when many equipments of the terminal supply mode are used, a significant working space is occupied by many cables, it is difficult to organize the cables, and an outer appearance is achieved. In addition, the terminal supply mode causes problems such as an instantaneous discharge phenomenon due to different potential differences between terminals, damage and fire due to impurities, natural discharge, and degradation in lifespan and performance of a battery.

Recently, to overcome the problems, a charging system (hereinafter, referred to as a “wireless charging system”) and control methods using a mode of wirelessly transmitting power have been proposed. In the past, a wireless charging system is not basically installed in some portable terminals and a consumer needs to purchase a separate accessory of a wireless charging receiver and, thus, a demand for a wireless charging system is low, but users of wireless charging are expected to be remarkably increased and, in the future, a terminal manufacturer is also expected to basically installed a wireless charging function.

In general, a wireless charging system includes a wireless power transmitter that supplies energy electrical energy in a wireless power transmission mode and a wireless power receiver that receives electrical energy supplied from the wireless power transmitter and charges a battery with the electrical energy.

The wireless charging system may transmit power in at least one wireless power transmission mode (e.g., an electromagnetic induction mode, an electromagnetic resonance mode, and a radio frequency (RF) wireless power transmission mode).

For example, the wireless power transmission mode may use various wireless power transmission standards based on an electromagnetic induction mode for performing charging using an electromagnetic induction principle whereby a power transmission end coil generates a magnetic field to induce electricity in a reception end coil by the influence of the magnetic field. Here, the wireless power transmission standard of the electromagnetic induction mode may include a wireless charging technology of an electromagnetic induction mode in the wireless power consortium (WPC) and/or the power matters alliance (PMA).

As another example, the wireless power transmission mode may use an electromagnetic resonance mode for transmitting power to a wireless power receiver positioned at a short distance via synchronization between a magnetic field generated by a transmission coil of a wireless power transmitter and a specific resonance frequency. Here, the electromagnetic resonance mode may include a wireless charging technology defined in the alliance for the wireless power (A4WP) standard institute that is a wireless charging technology standard institute.

As another example, the wireless power transmission mode may use an RF wireless power transmission mode for transmitting power to a wireless power receiver positioned at a long distance by delivering low power energy in an RF signal.

The wireless charging system may be designed to support at least two or more wireless power transmission modes of the electromagnetic induction mode, the electromagnetic resonance mode, and the RF wireless power transmission mode. In other words, the wireless power transmitter may be designed to transmit power to the wireless power receiver in a plurality of wireless power transmission modes.

Accordingly, there is a need for a transition method of a power transmission mode between a plurality of wireless power transmission modes in one wireless charging system.

### DISCLOSURE

### Technical Problem

Embodiments provide an operation method of a wireless power receiver and an operation method of a wireless power transmitter.

Further, embodiments provide an operation method of a wireless power receiver and an operation method of a wireless power transmitter, for transition of a power transmission mode to another mode during power transmission in a specific mode.

It is to be understood that both the foregoing general description and the following detailed description of the present disclosure are exemplary and explanatory and are intended to provide further explanation of the present disclosure as claimed.

### Technical Solution

In one embodiment, an operation method of a wireless power receiver and an operation method of a wireless power transmitter are provided.

In one embodiment, an operation method of a wireless power receiver for supporting an electromagnetic resonance mode and an electromagnetic induction mode includes determining whether a power transfer mode needs transition during wireless charging in the electromagnetic induction mode, making a request to a wireless power transmitter for transition of the power transfer mode using extended end of charge information when the power transfer mode needs to transition, and receiving power in a power transfer mode that is determined according to whether the wireless power transmitter is connected in the electromagnetic resonance mode.

In some embodiments, the determining of whether the power transfer mode needs to transition may include determining whether error whereby a voltage of the wireless power receiver is not stabilized within a predetermined range is maintained to exceed a predetermined time.

In some embodiments, the determining of whether the power transfer mode needs to transition may include determining whether current of the wireless power receiver is equal to or less than minimum current.

In some embodiments, the determining of whether the power transfer mode needs to transition may include determining whether power transmission efficiency between the wireless power transmitter and the wireless power receiver is equal to or less than a threshold value.

In some embodiments, the making a request for transition of the power transfer mode may include setting the PMA EOP Reason of the extended end of charge information to a specific code, and the specific code may be voltage stabilization error or mode transition.

In some embodiments, the making a request for transition of the power transfer mode may include setting the Tx sleep of the extended end of charge information to a specific time or less.

In some embodiments, the Tx sleep may be a reference time for completing transition of the power transfer mode.

In another embodiment, an operation method of a wireless power transmitter for supporting an electromagnetic resonance mode and an electromagnetic induction mode includes receiving extended end of charge information from a wireless power receiver during wireless charging in the electromagnetic induction mode, determining whether the wireless power receiver makes a request for transition of a power transfer mode using the extended end of charge information, and upon making a request for transition of the power transfer mode, transmitting power in a power transfer mode that is determined according to whether the wireless power transmitter is connected in the electromagnetic resonance mode.

It is to be understood that both the foregoing general description and the following detailed description of the present disclosure are exemplary and explanatory and are intended to provide further explanation of present disclosure as claimed.

### Advantageous Effects

An operation method of a wireless power receiver and an operation method of a wireless power transmitter according to the present disclosure may have the following effects.

According to the present disclosure, when a problem occurs in that efficiency is not good or unstable during power transmission in an electromagnetic induction mode, power transmission may be attempted in the electromagnetic induction mode to enhance power transmission and reception efficiency of a wireless power transmitter and a wireless power receiver.

According to the present disclosure, the detailed communication standard for transition of a power transfer mode may be defied while using the published wireless power transfer standard.

It will be appreciated by persons skilled in the art that the effects that could be achieved with the present disclosure are not limited to what has been particularly described hereinabove and other advantages of the present disclosure will be more clearly understood from the following detailed description taken in conjunction with the accompanying drawings.

### DESCRIPTION OF DRAWINGS

Arrangements and embodiments may be described in detail with reference to the following drawings in which like reference numerals refer to like elements and wherein:

FIG. 1 is a block diagram for explanation of a wireless charging system according to an embodiment;

FIG. 2 is a block diagram for explanation of a structure of a wireless power transmitter for supporting a multimode according to an embodiment;

FIG. 3 is a block diagram for explanation of a structure of a resonance transmitter according to an embodiment;

FIG. 4 is a block diagram for explanation of a structure of an induction transmitter according to an embodiment;

FIG. 5 is a block diagram for explanation of a structure of a wireless power receiver that is operatively associated with the wireless power transmitter shown in FIG. 4;

FIG. 6 is a state transition diagram for explanation of a wireless power transmission procedure defined in the wireless power consortium (WPC) standard;

FIG. 7 is a state transition diagram for explanation of a wireless power transmission procedure defined in the power matters alliance (PMA) standard;

FIG. 8 is a state transition diagram of a wireless power receiver for supporting an electromagnetic resonance mode according to an embodiment;

FIG. 9 is a state transition diagram for explanation of a state transition procedure of a wireless power transmitter for supporting an electromagnetic resonance mode according to an embodiment;

FIG. 10 is a flowchart for explanation of an operation of a wireless power transmitter and a wireless power receiver, for supporting a multimode wireless power transmission mode according to an embodiment of the present disclosure;

FIG. 11 is a flowchart for explanation of a mode transition algorithm according to an embodiment; and

FIG. 12 is a flowchart for explanation of a mode transition algorithm according to another embodiment of the present disclosure.

### BEST MODE

An operation method of a wireless power receiver for supporting an electromagnetic resonance mode and an electromagnetic induction mode according to a first embodiment of the present disclosure may include determining whether a power transfer mode needs transition during wireless charging in the electromagnetic induction mode, making a request to a wireless power transmitter for transition of the power transfer mode using extended end of charge information when the power transfer mode needs to transition, and receiving power in a power transfer mode that is determined according to whether the wireless power transmitter is connected in the electromagnetic resonance mode.

### Mode for Invention

Hereinafter, devices and various methods, to which embodiments of the present disclosure are applied, will be described in more detail with reference to the accompanying drawings. The suffixes “module” and “unit” of elements herein are used for convenience of description and thus can be used interchangeably and do not have any distinguishable meanings or functions.

In description of exemplary embodiments, it will be understood that, when an element is referred to as being “on” or “under” another element, the element can be directly on another element or intervening elements may be present. In addition, when an element is referred to as being “on” or “under” another element, this may include the meaning of an upward direction or a downward direction based on one component.

In the following description of the present disclosure, for convenience of description, an apparatus for wirelessly transmitting power in a wireless charging system may be used interchangeably with a wireless power transmitter, a wireless power transmission apparatus, a wireless power transmission device, a wireless power transmitter, a transmission end, a transmitter, a transmission apparatus, a transmission side, a wireless charging apparatus, etc. In addition, for convenience of description, an apparatus with a function of wirelessly receiving power from a wireless power transmission apparatus may be used interchangeably with a wireless power reception apparatus, a wireless power receiver, a wireless power reception device, a reception terminal, a reception side, a reception apparatus, a receiver, etc.

A transmitter according to the present disclosure may be configured in the form of a pad, a cradle, an access point (AP), a small base station, a stand, a ceiling insert type, a wall-hanging type, a vehicle insert type, a vehicle mount type, or the like or one transmitter may transmitter may transmit power to a plurality of a wireless power reception apparatus. To this end, the transmitter may include at least one wireless power transmission element. Here, the wireless power transmission element may use various wireless power transmission standards based on an electromagnetic induction mode in which electricity is charged using an electromagnetic induction principle whereby magnetic field is generated from a power transmission end coil to induce electricity in a reception end coil due to influence of the magnetic field. Here, the wireless power transmission element may include wireless charging technology of an electromagnetic induction mode defined in the electromagnetic induction mode (WPC) and the power matters alliance (PMA) as the wireless charging technology standard organization.

A receiver according to an embodiment may include at least one wireless power reception element and may wirelessly and simultaneously receive power from two or more transmitters. Here, the wireless power reception element may include wireless charging technology of an electromagnetic induction mode defined in the electromagnetic induction mode (WPC) and the power matters alliance (PMA) as the wireless charging technology standard organization.

A receiver according to the present disclosure may be mounted on a small-size electronic apparatus such as a mobile phone, a smartphone, a laptop, a digital broadcasting terminal, a personal digital assistants (PDA), a portable multimedia player (PMP), a navigation system, an MP3 player, an electric toothbrush, a radio frequency identification (RFID) tag, an illumination apparatus, a remote controller, a bobber, and a wearable device such as a smart watch, without being limited thereto. Accordingly, the receiver according to the present disclosure may be any mobile device that includes a wireless power reception element according to the present disclosure to charge a battery.

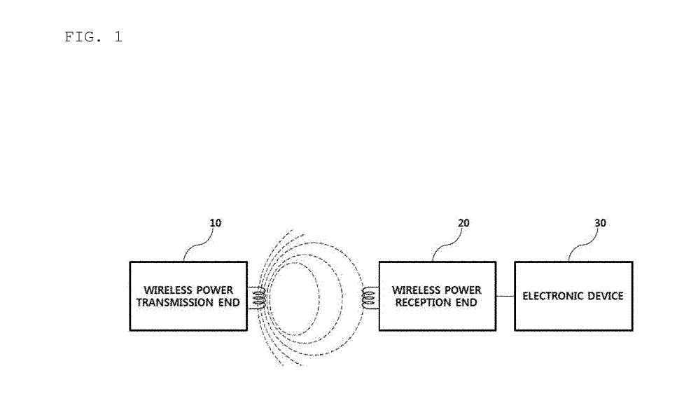

FIG. 1 is a block diagram for explanation of a wireless charging system according to an embodiment.

Referring to FIG. 1, the wireless charging system may broadly include a wireless power transmission end 10 for wirelessly transmitting power, a wireless power reception end for receiving the transmitted power, and an electronic device 30 for supplying the received power.

For example, the wireless power transmission end 10 and the wireless power reception end 20 may perform in-band communication for exchanging information using the same frequency band as an operation frequency used in wireless power transmission. As another example, the wireless power transmission end 10 and the wireless power reception end 20 may also perform out-of-band communication for exchanging information using a separate different frequency band from the operation frequency used in wireless power transmission.

For example, the information exchanged between the wireless power transmission end 10 and the wireless power reception end 20 may include control information as well as state information of each other. Here, the state information and the control information that are exchanged between the transmission and reception ends may be further obvious through the following descriptions of embodiments.

The in-band communication and the out-of-band communication may provide bi-directional communication, without being limited thereto, but, according to another embodiment, may provide unidirectional communication or half-duplex communication.

For example, the unidirectional communication refers to transmission of information only to the wireless power transmission end 10 from the wireless power reception end 20, without being limited thereto, but the wireless power transmission end 10 may also transmit information to the wireless power reception end 20.

In the half-duplex communication method, bi-directional communication is enabled between the wireless power reception end 20 and the wireless power transmission end 10, but only any one of the wireless power reception end 20 and the wireless power transmission end 10 is capable of transmitting information at any one time point.

The wireless power reception end 20 according to an embodiment may acquire various state information items of the electronic device 30. For example, the state information of the electronic device 30 may include current power usage information, information for identifying executed application, CPU usage information, battery charging state information, battery output voltage/current information, and so on, without being limited thereto, and may include any information that is capable of being acquired from the electronic device 30 and being used in wireless power control.

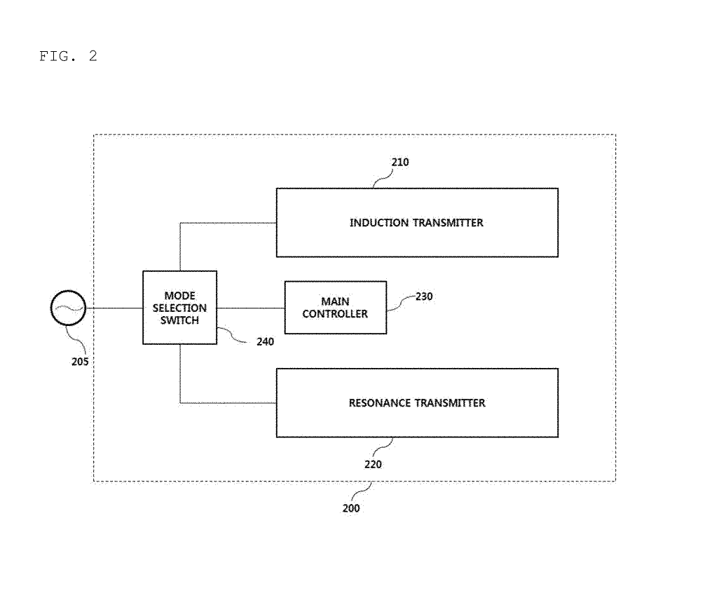

FIG. 2 is a block diagram for explanation of a structure of a wireless power transmitter for supporting a multimode according to an embodiment.

Referring to FIG. 2, a wireless power transmitter 200 may correspond to the wireless power transmission end 10 shown in FIG. 1. The wireless power transmitter 200 may broadly include an induction transmitter 210, a resonance transmitter 220, a main controller 230, and a mode selection switch 240, without being limited thereto.

The mode selection switch 240 may be connected to a power source 205 and may provide a switching function of transmitting power supplied from the power source 205 to the induction transmitter 210 and/or the resonance transmitter 220 according to control of the main controller 230.

The power source 205 according to another embodiment may correspond to power supplied through an external power terminal or a battery installed in the wireless power transmitter 200.

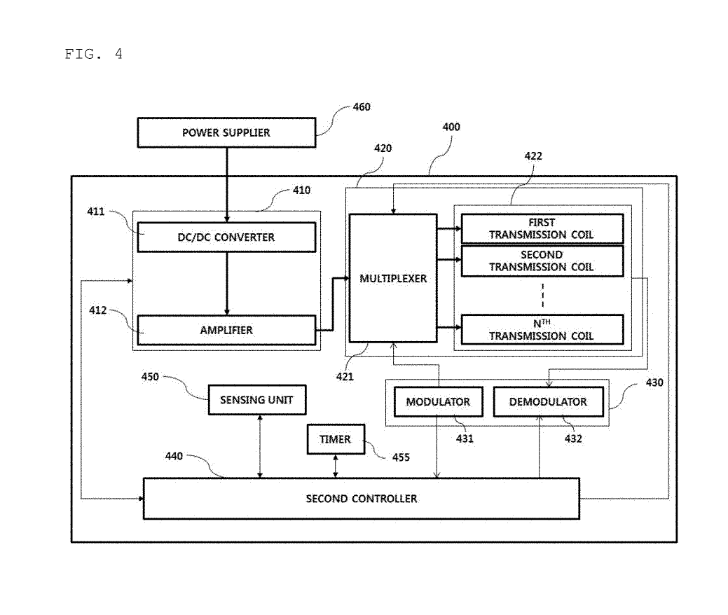

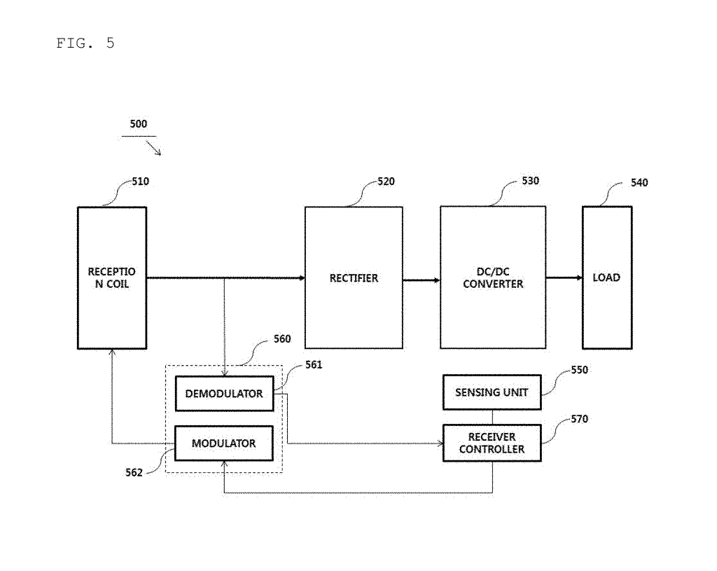

The induction transmitter 210 may be a device for wirelessly transmitting power to a receiver in an electromagnetic induction mode and may be operated according to the PMA or WPC standard. A configuration and operation of the induction transmitter 210 is described below in detail with reference to FIGS. 4 and 5.

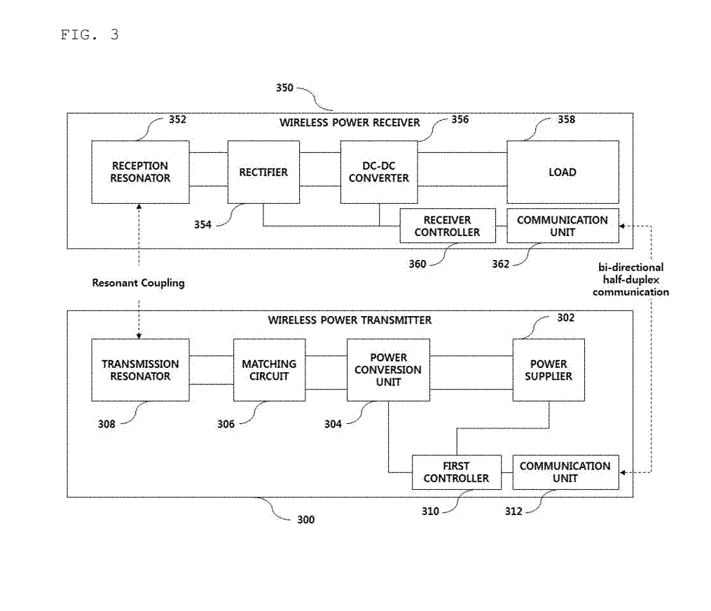

The resonance transmitter 220 may be a device for wirelessly transmitting power to a receiver in the electromagnetic resonance mode and may be operated according to the A4WP standard. A configuration and operation of the resonance transmitter 220 is described below in detail with reference to FIG. 3.

The main controller 230 may control an overall operation of the wireless power transmitter 200. In particular, the main controller 230 may adaptively determine a wireless power transmission mode based on the characteristic, state, and so on of a wireless power receiver and may control the mode selection switch 240 according to the determined wireless power transmission mode.

The main controller 230 may control the mode selection switch 240 to transition a current wireless power transmission mode to another wireless power transmission mode according to a request from the wireless power receiver.

The wireless power transmitter 200 may be a multimode transmitter for supporting both an electromagnetic induction mode and an electromagnetic resonance mode and the multimode transmitter may provide a wireless charging service to a single mode receiver as well as an alternative mode. In this case, the multimode transmitter may transmit power to at least one receiver.

The wireless charging mode selection and transition procedure between the multimode transmitter and the alternative mode may be transparently executed to a user without separate user intervention.

The multimode transmitter may be classified into a first multimode transmitter and a second multimode transmitter according to whether the corresponding transmitter is capable of simultaneously transmitting power in both the electromagnetic resonance mode and the electromagnetic induction mode.

The first multimode transmitter may simultaneously transmit power in the electromagnetic resonance mode and the electromagnetic induction mode.

The first multimode transmitter may transmit power to a plurality of receivers in the electromagnetic resonance mode and, simultaneously, may transmit power to one receiver in the electromagnetic induction mode.

The first multimode transmitter according to an embodiment may perform a receiver detection procedure defined in an electromagnetic resonance mode and an electromagnetic induction mode via time division interleaving and may initiate a session establishment procedure with a detected receiver in a wireless charging mode in which the receiver is first detected. In this case, when the session establishment procedure is initiated, the receiver detection procedure may be immediately terminated. With regard to time division interleaving in the electromagnetic resonance mode and the electromagnetic induction mode for detection of a receiver, a time and sequence for transmitting signals for detection of the receiver for each wireless charging mode needs to be defined to satisfy time requirements defined in the standard corresponding to each wireless charging mode, without being limited thereto.

When the session establishment procedure is not normally completed, the first multimode transmitter may restart the receiver detection procedure.

Upon verifying that the detected receiver is an alternative mode, the first multimode transmitter may determine whether a current mode needs to transition to an alternative mode. As a determination result, when the current mode needs to transition to an alternative mode, the first multimode transmitter may perform a predetermined transition procedure to the alternative mode. On the other hand, when the current mode does not need to transition to the alternative mode, the first multimode transmitter may maintain a current operation mode to provide a wireless charging service.

In a state in which power is wirelessly transmitted in any one of wireless charging modes, hereinafter referred to as a first wireless charging mode for convenience of description, when the first multimode transmitter is verified to attempt to establish a session to a second wireless charging mode from a second alternative mode, the first multimode transmitter may block establishment of the session with the corresponding second alternative mode.

The second multimode transmitter may operate only in any one of wireless charging modes at any one time point.

When a receiver that currently transmits power is not present, the second multimode transmitter may perform a receiver detection procedure according to a predefined rule.

Here, with regard to the receiver detection procedure, receiver detection procedures that are defined for the electromagnetic resonance mode and the electromagnetic induction mode, respectively, may be defined to perform time division interleaving thereon. Needless to say, the receiver detection procedure with time division interleaving performed thereon needs to be defined to satisfy time requirements of a receiver detection procedure, corresponding to the standard corresponding to each receiver detection procedure.

According to an embodiment, in a state in which power is wirelessly transmitted in any one of wireless charging modes, the second multimode transmitter may not perform a receiver detection procedure in another wireless charging mode. The second multimode transmitter may restart the receiver detection procedure when wireless charging to the corresponding receiver is completed or wireless power transmission is terminated.

The second multimode transmitter may also provide a predetermined user interface for allowing a user to identify a currently activated wireless charging mode. For example, the currently activated wireless charging mode may be displayed using light emitting diodes (LEDs) with different colors but this is merely an embodiment and, according to another embodiment, the currently activated wireless charging mode may be displayed through a liquid crystal display (LCD) installed in the second multimode transmitter.

The first multimode transmitter and the second multimode transmitter broadcast a predetermined transmitter multimode broadcast message for notifying the receiver of multimode capability. Here, the transmitter multimode broadcast message may include information for identifying a supportable wireless charging mode, a power class for each supportable wireless charging mode, and so on.

The multimode transmitter may receive different messages for receiving charging state information of a receiver depending on an activated wireless charging mode. For example, the A4WP standard using the electromagnetic resonance mode may define a power receiving unit (PRU) alert message for reporting that charging is completed to the transmitter. On the other hand, the PMA standard using the electromagnetic induction mode may define an end of charge (EOC) request message for reporting that charging is completed to the transmitter.

The main controller 230 may control the induction transmitter 210 and the resonance transmitter 220 to control intensity of a power signal transmitted through a coil.

FIG. 3 is a block diagram for explanation of a structure of a resonance transmitter according to an embodiment.

Referring to FIG. 3, the wireless power charging system may include a wireless power transmitter 300 and a wireless power receiver 350. The wireless power transmitter 300 may correspond to the resonance transmitter 220 shown in FIG. 2.

Although FIG. 3 illustrates the case in which the wireless power transmitter 300 wirelessly transmits power to one wireless power receiver 350, this is merely an embodiment and, thus, according to another embodiment of the disclosure, the wireless power transmitter 300 may wirelessly transmit power to the plurality of wireless power receivers 350. It is noted that, according to another embodiment of the disclosure, the wireless power receiver 350 may wirelessly and simultaneously receive power from the wireless power transmitters 300.

The wireless power transmitter 300 may generate a magnetic field using a specific power transmission frequency and transmit power to the wireless power receiver 350.

The wireless power receiver 350 may receive power in synchronization with the same frequency as a frequency used by the wireless power transmitter 300.

For example, a frequency used for power transmission may be a band of 6.78 MHz, without being limited thereto.

That is, power transmitted by the wireless power transmitter 300 may be transmitted to the wireless power receiver 350 that resonates with the wireless power transmitter 300.

A maximum number of wireless power receivers 350 capable of receiving power from one wireless power transmitter 300 may be determined based on a maximum transmission power level of the wireless power transmitter 300, a maximum power reception level of the wireless power receiver 350, and physical structures of the wireless power transmitter 300 and the wireless power receiver 350.

The wireless power transmitter 300 and the wireless power receiver 350 may perform bi-directional communication with a different frequency band from a frequency for wireless power transmission, i.e. a resonance frequency band. For example, the bi-directional communication may use a half-duplex Bluetooth low energy (BLE) communication protocol.

The wireless power transmitter 300 and the wireless power receiver 350 may exchange each other's characteristics and state information, i.e. power negotiation information through the bi-directional communication.

For example, the wireless power receiver 350 may transmit predetermined power reception state information for controlling a level of power received from the wireless power transmitter 300 to the wireless power transmitter 300 through bi-directional communication, and the wireless power transmitter 300 may dynamically control a transmitted power level based on the received power reception state information. As such, the wireless power transmitter 300 may optimize power transmission efficiency and may also perform a function of preventing a load from being damaged due to overvoltage, a function of preventing unnecessary power from being wasted due to under voltage, and so on.

The wireless power transmitter 300 may perform a function of authenticating and identifying the wireless power receiver 350 through bi-directional communication, a function of identifying an incompatible apparatus or a non-rechargeable object, a function for identifying a valid load, and so on.

Hereinafter, a wireless power transmission procedure of a resonance mode will be described in more detail.

The wireless power transmitter 300 may include a power supplier 302, a power conversion unit 304, a matching circuit 306, a transmission resonator 308, a first controller 310, and a communication unit 312.

The power supplier 302 may apply a specific supplied voltage to the power conversion unit 304 under control of the first controller 310. In this case, the applied voltage may be a DC voltage or an AC voltage.

The power conversion unit 304 may convert a voltage received from the power supplier 302 into a specific voltage under control of the first controller 310. To this end, the power conversion unit 304 may include at least one of a DC/DC convertor, an AC/DC convertor, and a power amplifier.

The matching circuit 306 may be a circuit for matching impedance between the power conversion unit 304 and the transmission resonator 308 to maximize power transmission efficiency.

The transmission resonator 308 may wirelessly transmit power using a specific resonance frequency depending on a voltage applied from the matching circuit 306.

The wireless power receiver 350 may include a reception resonator 352, a rectifier 354, a DC-DC converter 356, a load 358, a receiver controller 360, and a communication unit 362.

The reception resonator 352 may receive power transmitted by the transmission resonator 308 through a resonance phenomenon.

The rectifier 354 may perform a function of converting an AC voltage applied from the reception resonator 352.

The DC-DC converter 356 may convert the rectified DC voltage into a specific DC voltage required by the load 358.

The receiver controller 360 may control operations of the rectifier 354 and the DC-DC converter 356 or may generate the characteristics and state information of the wireless power receiver 350 to transmit the characteristics and state information to the communication unit 362. For example, the receiver controller 360 may monitor output voltages and current intensity of the rectifier 354 and the DC-DC converter 356 and control operations of the rectifier 354 and the DC-DC converter 356.

Information on the monitored output voltages and current intensity may be transmitted to the wireless power transmitter 300 through the communication unit 362 in real time.

The receiver controller 360 may compare the rectified DC voltage with a predetermined reference voltage to determine whether a current state is an over-voltage state or an under-voltage state, and upon detecting a system error state as the determination result, the receiver controller 360 may transmit the detection result to the wireless power transmitter 300 through the communication unit 362.

Upon detecting a system error state, the receiver controller 360 may control operations of the rectifier 354 and the DC-DC converter 356 or control power supplied to the load 358 using a predetermined overcurrent cutoff circuit including a switch or(and) a Zener diode to prevent a load from being damaged.

Although FIG. 3 illustrates the case in which the controller 310 or 360 and the communication unit 312 or 362 of each of the transmitter and the receiver are configured as different modules, this is merely an embodiment and, thus, according to another embodiment, it is noted that the controller 310 or 360 and the communication unit 312 or 362 may each be configured as one module.

When a new wireless power receiver is added to a charging region during charging, when access with a wireless power receiver is released during charging, or an event of completing charging of the wireless power receiver is detected, the wireless power transmitter 300 according to an embodiment may also perform a power redistribution procedure for the other wireless power receivers as a charging target. In this case, the power redistribution result may be transmitted to the connected wireless power receiver(s) via out-of-band communication.

FIG. 4 is a block diagram for explanation of a structure of an induction transmitter according to an embodiment.

Referring to FIG. 4, a wireless power transmitter 400 may broadly include a power converter 410, a power transmitter 420, a communication unit 430, a second controller 440, and a sensing unit 450. The components of the wireless power transmitter 400 are not necessary and, thus, it may be noted that greater or fewer components than in FIG. 4 may constitute the wireless power transmitter 400. The wireless power transmitter 400 may correspond to the induction transmitter 210 shown in FIG. 2.

As shown in FIG. 4, upon receiving power from a power supplier 460, the power converter 410 may perform a function of converting the power to power with predetermined intensity.

To this end, the power converter 410 may include a DC/DC converter 411 and an amplifier 412.

The DC/DC converter 411 may perform a function of converting DC power supplied from the power supplier 460 into DC power with specific intensity according to a control signal of the controller 440.

In this case, the sensing unit 450 may measure voltage/current of the DC converted power, and so on and may provide the measured voltage/current to the controller 440. The sensing unit 450 may measure internal temperature of the wireless power transmitter 400 to determine whether overheat is generated and may provide the measurement result to the controller 440. For example, the controller 440 may adaptively block power from the power supplier 460 based on the voltage/current value measured by the sensing unit 450 or may prevent power from being supplied to the amplifier 412. To this end, a power blocking circuit for blocking power supplied from the power supplier 460 or blocking power supplied to the amplifier 412 may be further provided at one side of the power converter 410.

The amplifier 412 may adjust intensity of the DC/DC converted power according to a control signal of the controller 440. For example, the controller 440 may receive power reception state information or (and) a power control signal of the wireless power receiver through the communication unit 430 and may dynamically adjust a amplification factor of the amplifier 412 based on the received reception state information or (and) power control signal. For example, the power reception state information may include intensity information of a rectifier output voltage, intensity information of current applied to a reception coil, and so on, without being limited thereto. The power control signal may include a signal for making a request for a power increase, a signal for making a request for power reduction, and so on.

The power transmitter 420 may include a multiplexer 421 (or a multiplexer) and a transmission coil 422. The power transmitter 420 may further include a carrier wave generation unit (not shown) for generating a specific operation frequency for power transmission.

The carrier wave generation unit may generate a specific frequency for converting output DC power of the amplifier 412, received through the multiplexer 421, into AC power with a specific frequency. Thus far, although the case in which an AC signal generated by the carrier wave generation unit is mixed with an output end of the multiplexer 421 to generate AC power has been described, this is merely an embodiment and, it may be noted that the AC signal is also mixed with a front end or a rear end of the amplifier 412.

According to an embodiment, it may be noted that AC power transmitted to each transmission coil has different frequencies. According to another embodiment, a resonance frequency for each transmission coil may be set to be different using a predetermined frequency controller with a function of differently adjusting LC resonance characteristics for the respective coils.

The power transmitter 420 may include the multiplexer 421 for control of transmission of output power of the amplifier 412 to the transmission coil and the plurality of transmission coils 422, i.e., first to n^{th} transmission coils.

According to an embodiment, when a plurality of wireless power receivers is connected, the controller 440 may transmit power through time division multiplexing for each transmission coil. For example, when three wireless power receivers, i.e., first to third wireless power receivers are identified through three different transmission coils, i.e., first to third transmission coils, the controller 440 may control the multiplexer 421 to transmit power to the wireless power transmitter 400 through a specific transmission coil in a specific timeslot. In this case, the amount of power transmitted to the corresponding wireless power receiver may be controlled depending on a length of a timeslot allocated to each transmission coil, but this is merely an embodiment and, thus, as another example, an amplification factor of the amplifier 412 during a timeslot allocated to each transmission coil may be controlled to control power transmitted to each wireless power receiver.

The controller 440 may control the multiplexer 421 to sequentially transmit detection signals through the first to n^{th} transmission coils 422 during a first detection signal transmitting procedure. In this case, the controller 440 may identify a time point when a detection signal is to be transmitted, using a timer 455 and, when the time point when the detection signal is to be transmitted is reached, the controller 440 may control the multiplexer 421 to transmit the detection signal through a corresponding transmission coil. For example, the timer 455 may transmit a specific event signal to the controller 440 with a predetermined period during a ping transmission operation and, upon detecting a corresponding event signal, the controller 440 may control the multiplexer 421 to transmit a digital ping through a corresponding transmission coil.

The controller 440 may receive a predetermined transmission coil identifier for identifying a transmission coil through which a signal strength indicator is received and the signal strength indicator received through a corresponding transmission coil, from a demodulator 432, during the first detection signal transmitting procedure. Continuously, in a second detection signal transmitting procedure, the controller 440 may control the multiplexer 421 to transmit a detection signal only through transmission coil(s) for receiving the signal strength indicator. As another example, when the signal strength indicator is received through a plurality of transmission coils during the first detection signal transmitting procedure, the controller 440 may determine a transmission coil for receiving a signal strength indicator with a largest value as a transmission coil for first transmitting a detection signal in the second detection signal transmitting procedure and may control the multiplexer 421 according to the determination result.

A modulator 431 may modulate a control signal generated by the controller 440 and may transmit the modulated control signal to the multiplexer 421. Here, a modulation method of modulating the control signal may include a frequency shift keying (FSK) modulation method, a Manchester coding modulation method, a phase shift keying (PSK) modulation method, a pulse width modulation method, a differential bi-phase modulation method, or the like, without being limited thereto.

Upon detecting a signal received through a transmission coil, the demodulator 432 may demodulate the detected signal and may transmit the demodulated signal to the controller 440. Here, the demodulated signal may include a signal strength indicator, an error correction (EC) indicator for power control during wireless power transmission, an end of charge (HOC) indicator, a overvoltage/overcurrent/overheat indicator, or the like, without being limited thereto and, thus, may include various state information items for identifying a state of a wireless power receiver.

The demodulator 432 may identify a transmission coil from which the demodulated signal is received and may provide a predetermined transmission coil identifier corresponding to the identified transmission coil to the controller 440.

The demodulator 432 may demodulate a signal received from the transmission coil 422 and may transmit the demodulated signal to the controller 440. For example, the demodulated signal may include a signal strength indicator, without being limited thereto and, thus, may include various state information items of a wireless power receiver.

For example, the wireless power transmitter 400 may acquire the signal strength indicator through in-band communication for communication with a wireless power receiver using the same frequency as a frequency used in wireless power transmission.

The wireless power transmitter 400 may exchange various information items with a wireless power receiver through the transmission coil 422 as well as may wirelessly transmit power using the transmission coil 422. As another example, it may be noted that the wireless power transmitter 400 further includes the transmission coils 422, i.e., first to n^{th} transmission coils and performs in-band communication with a wireless power receiver using a separate included coil.

Although the case in which the wireless power transmitter 400 and the wireless power receiver perform in-band communication has been described thus far with reference to FIG. 4, this is merely an embodiment and, thus, the wireless power transmitter 400 and the wireless power receiver may perform short distance bi-directional communication through a different frequency band from a frequency band used for wireless power signal transmission. For example, the short distance bi-directional communication may be any one of Bluetooth low energy communication, radio frequency identification (RFID) communication, ultra wide band (UWB) communication, and ZigBee communication.

FIG. 5 is a block diagram for explanation of a structure of a wireless power receiver that is operatively associated with the wireless power transmitter shown in FIG. 4.

Referring to FIG. 5, a wireless power receiver 500 may include a reception coil 510, a rectifier 520, a DC/DC converter 530, a load 540, a sensing unit 550, a communication unit 560, and a receiver controller 570. Here, the communication unit 560 may include a demodulator 561 and a modulator 562.

Although the case in which the wireless power receiver 500 shown in FIG. 5 exchanges information with the wireless power transmitter 400 through in-band communication has been described above, this is merely an embodiment and, thus, the communication unit 560 according to another embodiment of the present disclosure may provide short distance bi-directional communication through a different frequency band from a frequency band used for wireless power signal transmission.

AC power received through the reception coil 510 may be transmitted to the rectifier 520. The rectifier 520 may convert AC power into DC power and may transmit the DC power to the DC/DC converter 530. The DC/DC converter 530 may convert intensity of the DC power output from the rectifier into specific intensity required by the load 540 and may transmit the converted power to the load 540.

The sensing unit 550 may measure the intensity of the DC power output from the rectifier 520 and may provide the measured intensity to the receiver controller 570. The sensing unit 550 may measure intensity of current applied to the reception coil 510 according to wireless power reception and may also transmit the measurement result to the receiver controller 570. The sensing unit 550 may measure internal temperature of the wireless power receiver 500 and may provide the measured temperature value to the receiver controller 570.

For example, the receiver controller 570 may compare the measured intensity of the DC power output from the rectifier and a predetermined reference value to determine whether overvoltage is generated. As the determination result, when overvoltage is generated, a predetermined packet indicating that overvoltage is generated may be generated and may be transmitted to the modulator 562. Here, the signal demodulated by the modulator 562 may be transmitted to the wireless power transmitter 400 through the reception coil 510 or a separate coil (not shown). When the intensity of the DC power output from the rectifier is equal to or less than a predetermined reference value, the receiver controller 570 may determine that a detection signal is received and, when detection signal is received, the receiver controller 570 may perform control to transmit the signal strength indicator corresponding to the corresponding detection signal to the wireless power transmitter 400 through the modulator 562. As another example, the demodulator 561 may demodulate an AC power signal between the reception coil 510 and the rectifier 520 or a DC power signal output from the rectifier 520, may identify whether the detection signal is received and, then, may provide the identification result to the receiver controller 570. In this case, the receiver controller 570 may perform control to transmit the signal strength indicator corresponding to the detection signal through the modulator 562.

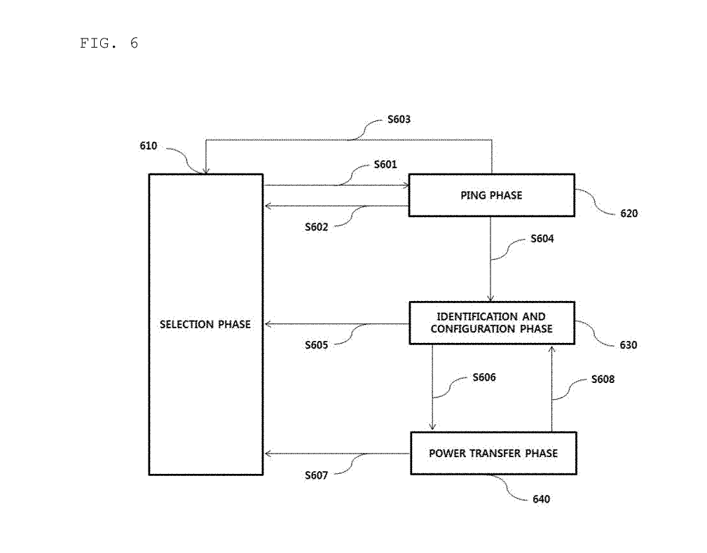

FIG. 6 is a state transition diagram for explanation of a wireless power transmission procedure defined in the wireless power consortium (WPC) standard.

Referring to FIG. 6, power transmission to a receiver from a transmitter according to the WPC standard may be broadly classified into a selection phase 610, a ping phase 620, an identification and configuration phase 630, and a power transfer phase 640.

The selection phase 610 may be a phase that transitions when a specific error or a specific event is detected while power transmissions is started or power transmission is maintained. Here, the specific error and the specific event would be obvious from the following description. In addition, in the selection phase 610, the transmitter may monitor whether an object is present on an interface surface. Upon detecting that the object is present on the interface surface, the transmitter may transition to the ping phase 620 (S601). In the selection phase 610, the transmitter may transmit an analog ping signal with a very short pulse and may detect whether an object is present in an activate area of the interface surface based on a current change of a transmission coil.

In the ping phase 620, upon detecting the object, the transmitter may activate the receiver and may transmit a digital ping for identifying whether the receiver is compatible with the WPC standard. In the ping phase 620, when the transmitter does not receive a response signal to the digital ping, e.g., a signal strength indicator from the receiver, the ping phase 620 may re-transition to the selection phase 610 (S602). In the ping phase 620, upon receiving a signal indicating that power transmission is completed, i.e., an end of power signal, from the receiver, the transmitter may transition to the selection phase 610 (S603).

When the ping phase 620 is completed, the transmitter may transition to the identification and configuration phase 630 for collecting receiver identification and receiver configuration and state information (S604).

In the identification and configuration phase 630, when the transmitter receives an unexpected packet or does not receive an expected packet for a predefined time period (time out), there is packet transmission error, or power transfer contract is not set, the transmitter may transition to the selection phase 610 (S605).

When identification and configuration of the receiver are completed, the transmitter may transition to the power transfer phase 640 for wirelessly transmitting power (S606).

In the power transfer phase 640, when the transmitter receives an unexpected packet or does not receive an expected packet for a predefined time period (time out), preset power transfer contract violation occurs, or charging is completed, the transmitter may transition to the selection phase 610 (S607).

In the power transfer phase 640, when power transfer contract needs to be re-configured depending on a state change in the transmitter, the transmitter may transition to the identification and configuration phase 630 (S608).

The power transfer contract may be set based on state and characteristics information of the transmitter and the receiver. For example, the state information of the transmitter may include information on a maximum transmissible power amount, information on the number of maximum acceptable receivers, and so on and the state information of the receiver may include information on required power, and so on.

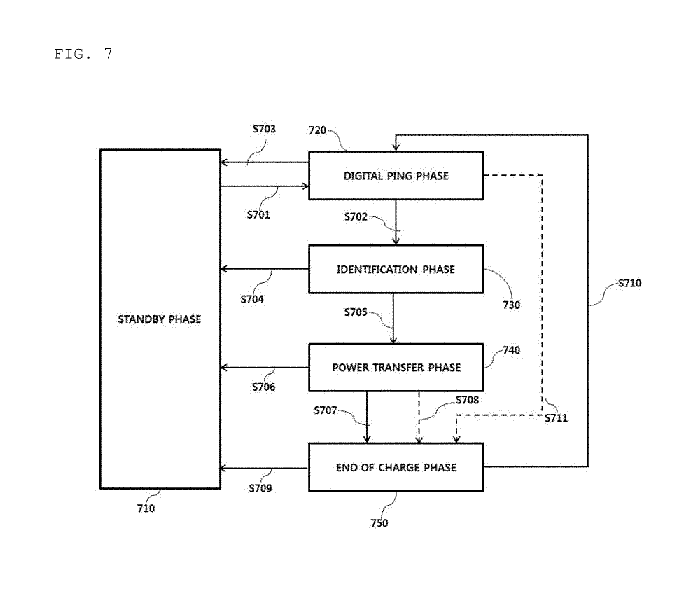

FIG. 7 is a state transition diagram for explanation of a wireless power transmission procedure defined in the power matters alliance (PMA) standard.

Referring to FIG. 7, power transmission to a receiver from a transmitter according to the PMA standard may be broadly classified into a standby phase 710, a digital ping phase 720, an identification phase 730, a power transfer phase 740, and an end of charge phase 750.

The standby phase 710 may be a phase that transitions when a specific error or a specific event is detected while a receiver identification procedure for power transmission is performed or power transmission is maintained. Here, the specific error and the specific event would be obvious from the following description. In addition, in the standby phase 710, the transmitter may monitor whether an object is present on a charging surface. When the transmitter detects that the object is present on the charging surface or is performing RXID reattempt, the standby phase 710 may transition to the digital ping phase 720 (S701). Here, RXID refers to a unique identifier (ID) allocated to a PMA compatible receiver. In the standby phase 710, the transmitter may transmit an analog ping with a very short pulse and may detect whether an object is present in an active area of an interface surface, e.g., a charging bed based on a current change of a transmission coil.

The transmitter that transitions to the digital ping phase 720 may emit a digital ping signal for identifying whether the detected object is a PMA compatible receiver. When sufficient power is supplied to a reception end according to the digital ping signal transmitted by the transmitter, the receiver may modulate the received digital ping signal according to a PMA communication protocol to transmit a predetermined response signal to a transmitter. Here, the response signal may include a signal strength indicator indicating intensity of power received by the receiver. In the digital ping phase 720, upon receiving an effective response signal, the receiver may transition to the identification phase 730 (S702).

When, in the digital ping phase 720, the transmitter does not receive the response signal or the corresponding receiver is not a PMA compatible receiver, i.e., in the case of foreign object detection (FOD), the transmitter may transition to the standby phase 710 (S703). For example, a foreign object (FO) may be a metallic object including a coin, a key, or the like.

In the identification phase 730, when the transmitter fails in a receiver identification procedure or needs to re-perform the receiver identification procedure and does not complete the receiver identification procedure within a predefined time period, the transmitter may transition to the standby phase 710 (S704).

Upon succeeding in receiver identification, the transmitter may transition to the power transfer phase 740 from the identification phase 730 and may initiate charging (S705).

In the power transfer phase 740, when the transmitter does not receive a desired signal within a predetermined time period (Time Out) or detects an FO, or a voltage of a reception coil exceeds a predefined reference value, the transmitter may transition to the standby phase 710 (S706).

In the power transfer phase 740, when temperature detected by a temperature sensor included in the transmitter exceeds a predetermined reference value, the transmitter may transition to the end of charge end 750 (S707).

In the end of charge end 750, upon checking that the receiver is removed from the charging surface, the transmitter may transition to the standby phase 710 (S709).

In an over-temperature state, when measured temperature is lowered to a reference value or less after a predetermined time period elapses, the transmitter may transition to the digital ping phase 720 from the end of charge end 750 (S710).

In the digital ping phase 720 or the power transfer phase 740, upon receiving an end of charge (EOC) request, the transmitter may transition to the end of charge end 750 (S708 and S711).

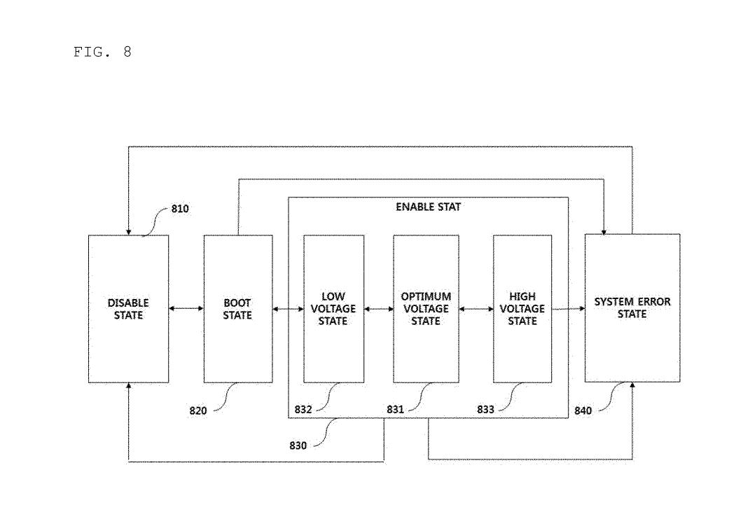

FIG. 8 is a state transition diagram of a wireless power receiver for supporting an electromagnetic resonance mode according to an embodiment.

Referring to FIG. 8, a state of the wireless power receiver may largely include a disable state 810, a boot state 820, an enable state 830 (or an on state), and a system error state 840.

In this case, the state of the wireless power receiver may be determined based on intensity, hereinafter, for convenience of description, referred to as V_{RECT}, of an output voltage at an end of a rectifier of the wireless power receiver.

The enable state 830 may be divided into an optimum voltage state 831, a low voltage state 832, and a high voltage state 833 according to a value of V_{RECT}.

When a measured value of V_{RECT} is equal to or greater than a predetermined value of V_{RECT_BOOT}, the wireless power receiver in the disable state 810 may transition to the boot state 820.

In the boot state 820, the wireless power receiver may establish an out-of-band communication link with the wireless power transmitter and may stand by until a value of V_{RECT} reaches power required at an end of a load.

Upon checking that the value of V_{RECT} reaches power required at the end of the load, the wireless power receiver in the boot state 820 may transition to the enable state 830 and may begin charging.

Upon checking that charging is completed or stopped, the wireless power receiver in the enable state 830 may transition to the boot state 820.

Upon detecting predetermined system error, a wireless power receiver in the enable state 830 may transition to the system error state 840. Here, system error may include a predefined other system error condition as well as overvoltage, overcurrent, and overheat.

When a value of V_{RECT} is lowered to a value of V_{RECT_BOOT} or less, a wireless power receiver in the enable state 830 may transition to the disable state 810.

In addition, when the value of V_{RECT} is lowered to the value of V_{RECT_BOOT} or less, a wireless power receiver in the boot state 820 or the system error state 840 may transition to the disable state 810.

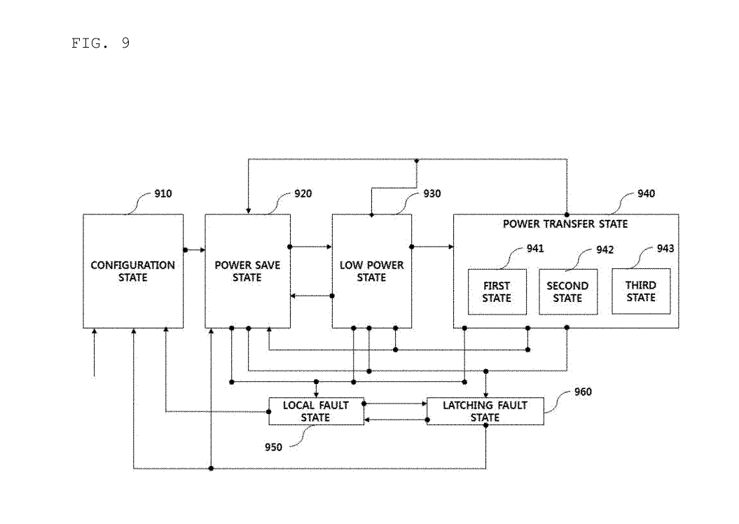

FIG. 9 is a state transition diagram for explanation of a state transition procedure of a wireless power transmitter for supporting an electromagnetic resonance mode according to an embodiment.

Referring to FIG. 9, a state of the wireless power transmitter may roughly include a configuration state 910, a power save state 920, a low power state 930, a power transfer state 940, a local fault state 950, and a latching fault state 960.

When power is supplied to a wireless power transmitter, the wireless power transmitter may transition to the configuration state 910. The wireless power transmitter may transition to the power save state 920 when a predetermined reset timer expires or an initialization procedure is completed in the configuration state 910.

In the power save state 920, the wireless power transmitter may generate a beacon sequence and transmit the beacon sequence through a resonance frequency band.

Here, the wireless power transmitter may perform control to enter the power save state 920 and to initiate the beacon sequence within a predetermined time. For example, the wireless power transmitter may perform control to initialize the beacon sequence within 50 ms after transition to the power save state 920, without being limited thereto.

In the power save state 920, the wireless power transmitter may periodically generate and transmit a first beacon sequence for detecting whether a conductive object is present in a charging region and may detect impedance variation of a reception resonator, i.e., load variation.

In the power save state 920, the wireless power transmitter may periodically generate and transmit a predetermined second beacon sequence for identifying of the detected object. In this case, transmission timing of a corresponding beacon may be determined in such a way that the first beam sequence and the second beacon sequence do not overlap with each other. Hereinafter, for convenience of description, the first beacon sequence and the second beacon sequence are referred to as a short beacon sequence and a long beacon sequence, respectively.

In particular, the short beacon sequence may be repeatedly generated and transmitted with a predetermined time interval t_{CYCLE} for a short period t_{SHORT_BEACON} so as to save standby power of the wireless power transmitter before the conductive object is detected in the charging region. For example, t_{SHORT_BEACON} may be set to 30 ms or less and t_{CYCLE} may be set to 250 ms±5 ms without being limited thereto. In addition, current intensity of each short beacon included in the short beacon sequence may be a predetermined reference value or more and may be gradually increased for a predetermined time.

According to the present disclosure, a wireless power transmitter may include a predetermined sensing element for detection of change in reactance and resistance by a reception resonator according to a short beacon.

In addition, in the power save state 920, the wireless power transmitter may periodically generate and transmit a second beacon sequence for supplying sufficient power required for booting and response of the wireless power receiver.

That is, when booting is completed through a long beacon sequence, the wireless power receiver may broadcast a predetermined response signal to the wireless power transmitter through an out-of-band communication channel.

In particular, In particular, the long beacon sequence may be generated and transmitted with a predetermined time interval t_{LONG_BEACON_PERIOD} for a relatively long period compared with a short beacon sequence to supply sufficient power required for booting of the wireless power receiver. For example, t_{LONG_BEACON} may be set to 105 ms+5 ms, t_{LONG_BEACON_PERIOD} may be set to 850 ms, and current intensity of a long beacon may be relatively high compared with current intensify of the short beacon. In addition, the long beacon may be maintained with power of predetermined intensity during a transmission period.

Then, the wireless power transmitter may be on standby to receive a predetermined response signal during a transmission period of the long beacon upon detecting change in impedance of a reception resonator. Hereinafter, for convenience of description, the response signal will be referred to as an advertisement signal. Here, the wireless power receiver may broadcast the advertisement signal through a different out-of-band communication frequency band from a resonance frequency band.

For example, the advertisement signal may include at least one or any one of message identification information for identifying a message defined in a corresponding out-of-band communication standard, unique service or wireless power receiver identification information for identifying whether a wireless power receiver is a proper receiver or a compatible receiver to a corresponding wireless power transmitter, output power information of a wireless power receiver, information on rated voltage/current applied to a load, antenna gain information of a wireless power receiver, information for identifying a category of a wireless power receiver, authentication information of a wireless power receiver, information on whether an overvoltage protection function is installed, and version information of software installed in a wireless power receiver.

Upon receiving an advertisement signal, the wireless power transmitter may transition to the low power state 930 from the power save state 920 and, then, may establish an out-of-band communication link with a wireless power receiver. Continuously, the wireless power transmitter may perform a registration procedure to a wireless power receiver through the established out-of-band communication link. For example, when out-of-band communication is Bluetooth low-power communication, the wireless power transmitter may perform Bluetooth pairing with the wireless power receiver and the transmitter and the receiver exchange at least one of state information, characteristics information, and control information with each other through the paired Bluetooth link.

When the wireless power transmitter transmits a predetermined control signal, i.e. a predetermined control signal for requesting a wireless power receiver to transmit power to a load, for initializing charging through out-of-band communication in the low power state 930 to the wireless power receiver, the wireless power transmitter may transition to the power transfer state 940 from the low power state 930.

When an out-of-band communication link establishment procedure or registration procedure is not normally completed in the low power state 930, the wireless power transmitter may transition to the power save state 920 from the low power state 930.

The wireless power transmitter may drive a separately divided link expiration timer for connection with each wireless power receiver and the wireless power receiver needs to transmit a predetermined message indicating that the receiver is present to the wireless power transmitter with a predetermined time before the link expiration timer expires. The link expiration timer may be reset whenever the message is received and an out-of-band communication link established between the wireless power receiver and the wireless power receiver may be maintained when the link expiration timer does not expire.

When all link expiration timers corresponding to out-of-band communication links established between a wireless power transmitter and at least one wireless power receiver expire in the low power state 930 or the power transfer state 940, the wireless power transmitter may transition to the power save state 920.

Upon receiving a valid advertisement signal from the wireless power receiver, the wireless power transmitter in the low power state 930 may drive a predetermined registration timer. In this case, when a registration timer expires, a wireless power transmitter in the low power state 930 may transition to the power save state 920. In this case, the wireless power transmitter may output a predetermined notification signal indicating registration failure through a notification display element, e.g. including an LED lamp, a display screen, and a beeper, included in the wireless power transmitter.

When all connected wireless power receivers are completely charged in the power transfer state 940, the wireless power transmitter may transition to the low power state 930.

In particular, the wireless power receiver may permit registration of a new wireless power receiver in the remaining states except for the configuration state 910, the local fault state 950, and the latching fault state 960.

In addition, the wireless power transmitter may dynamically control transmitted power based on state information received from the wireless power receiver in the power transfer state 940.

In this case, receiver state information transmitted to the wireless power transmitter from the wireless power receiver may include at least one of required power information, information on voltage and/or current measured at a rear end of a rectifier, charging state information, information for announcing overcurrent, overvoltage, and/or overheating states, and information indicating whether an element for shutting off or reducing power transmitted to a load is activated according to overcurrent or overvoltage. In this case, the receiver state information may be transmitted at a predetermined period or may be transmitted whenever a specific event occurs. In addition, the element for shutting off or reducing power transmitted to a load according overcurrent or overvoltage may be provided using at least one of an ON/OFF switch and a Zener diode.

According to another embodiment, the receiver state information transmitted to the wireless power transmitter from the wireless power receiver may further include at least one of information indicating that external power is connected to the wireless power receiver by wire and information indicating that an out-of-band communication mode is changed, e.g. near field communication (NFC) may be changed to Bluetooth low energy (BLE) communication.

According to another embodiment, a wireless power transmitter may adaptively determine intensity of power to be received for each wireless power receiver based on at least one of current available power of the wireless power transmitter, priority for each wireless power receiver, and the number of connected wireless power receivers. Here, the intensity of power to be transmitted for each wireless power receiver may be determined as a ratio for receiving power based on maximum power to be processed by a rectifier of a corresponding wireless power receiver.

Then, the wireless power transmitter may transmit a predetermined power adjustment command containing information on the determined power intensity to the corresponding wireless power receiver. In this case, the wireless power receiver may determine whether power is capable of being controlled in the power intensity determined by the wireless power transmitter and may transmit the determination result to the wireless power transmitter through a predetermined power adjustment response message.

According to another embodiment, the wireless power receiver may transmit predetermined receiver state information indicating whether wireless power adjustment is possible according to the power adjustment command of the wireless power transmitter prior to reception of the power adjustment command.

The power transfer state 940 may be any one of a first state 941, a second state 942, and a third state 943 according to a power reception state of a connected wireless power receiver.

For example, the first state 941 may refer to a state in which power reception states of all wireless power receivers connected to the wireless power transmitter are each a normal voltage state.

The second state 942 may refer to a state in which a power reception state of at least one wireless power receiver connected to the wireless power transmitter is a low voltage state and a wireless power receiver of a high voltage state is not present.

The third state 943 may refer to a state in which a power reception state of at least one wireless power receiver connected to the wireless power transmitter is a high voltage state.

Upon detecting system error in the power save state 920, the low power state 930, or the power transfer state 940, the wireless power transmitter may transition to the latching fault state 960.

Upon determining that all connected wireless power receivers are removed from a charging region, the wireless power transmitter in the latching fault state 960 may transition to the configuration state 910 or the power save state 920.

In addition, upon detecting local fault in the latching fault state 960, the wireless power transmitter may transition to the local fault state 950. Here, when local fault is released, the wireless power transmitter in the local fault state 950 may re-transition to the latching fault state 960.

On the other hand, when the wireless power transmitter transitions to the local fault state 950 from any one of the configuration state 910, the power save state 920, the low power state 930, and the power transfer state 940, if local fault is released, the wireless power transmitter may transition to the configuration state 910.

When the wireless power transmitter transitions to the local fault state 950, power supplied to the wireless power transmitter may be shut off. For example, upon detecting fault such as overvoltage, overcurrent, and overheating, the wireless power transmitter may transition to the local fault state 950, without being limited thereto.

For example, upon detecting overvoltage, overcurrent, overheating, or the like, the wireless power transmitter may transmit a predetermined power adjustment command for reducing intensity of power received by the wireless power receiver to at least one connected wireless power receiver.

As another example, upon detecting overvoltage, overcurrent, overheating, or the like, the wireless power transmitter may transmit a predetermined control command for stopping charging of the wireless power receiver to at least one connected wireless power receiver.

Through the aforementioned power adjustment procedure, the wireless power transmitter may prevent a device from being damaged due to overvoltage, overcurrent, overheating, or the like.

When intensity of output current of a transmission resonator is a reference value or more, the wireless power transmitter may transition to the latching fault state 960. In this case, the wireless power transmitter that has transitioned to the latching fault state 960 may attempt to adjust the intensity of the output current of the transmission resonator to a reference value or less for a predetermined time. Here, the attempt may be repeatedly performed a predetermined number of times. Despite repeated performance, when the latching fault state 960 is not released, the wireless power transmitter may transmit a predetermined notification signal indicating that the latching fault state 960 is not released, to a user using a predetermined notification element. In this case, when all wireless power receivers positioned in the charging region of the wireless power transmitter are removed by the user, the latching fault state 960 may be released.

On the other hand, when intensity of output current of a transmission resonator is reduced to a reference value or less within a predetermined time or the intensity of output current of the transmission resonator is reduced to a reference value or less during the predetermined repeated performance, the latching fault state 960 may be automatically released, and in this case, the wireless power transmitter may automatically transition to the power save state 920 from the latching fault state 960 and may re-perform detection and identification procedures on the wireless power receiver.

The wireless power transmitter in the power transfer state 940 may transmit consecutive power and may adaptively control the transmitted power based on state information of the wireless power receiver and a predefined optimal voltage region setting parameter.

For example, the optimal voltage region setting parameter may include at least one of a parameter for identifying a low voltage region, a parameter for identifying an optimal voltage region, a parameter for identifying a high voltage region, and a parameter for identifying an overvoltage region.

When a power reception state of the wireless power receiver is in a low voltage region, the wireless power transmitter may increase transmitted power, and when the power reception state is in a high voltage region, the wireless power transmitter may reduce transmitted power.

The wireless power transmitter may control transmitted power to maximize power transmission efficiency.

The wireless power transmitter may control transmitted power such that a deviation of a power amount required by the wireless power receiver is a reference value or less.

In addition, when an output voltage of a rectifier of a wireless power receiver reaches a predetermined overvoltage region, i.e. when an overvoltage is detected, the wireless power transmitter may stop power transmission.

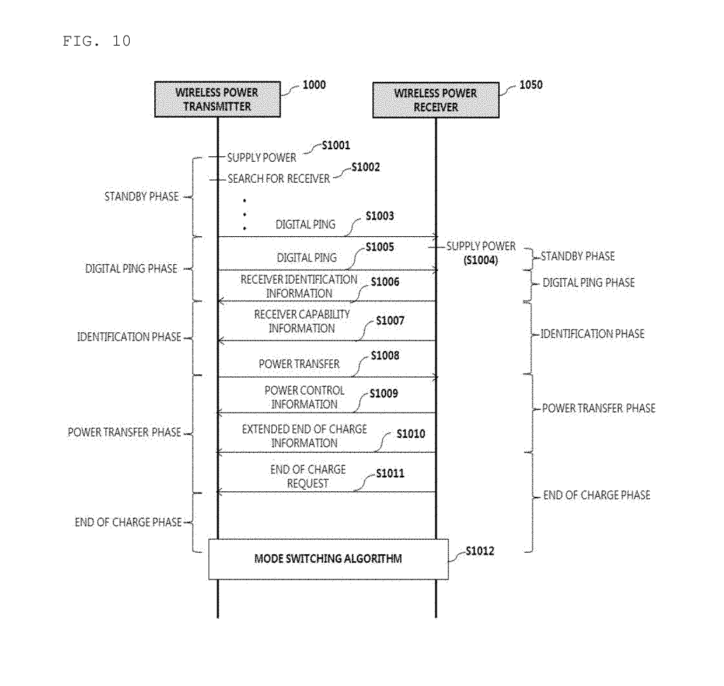

Hereinafter, a transition method to an electromagnetic resonance mode from an electromagnetic induction mode based on the aforementioned electromagnetic induction mode and electromagnetic resonance mode is described with reference to FIGS. 10 to 12. However, first, a multimode power transmission method for supporting both the electromagnetic resonance mode and the electromagnetic induction mode is described.

A wireless power transmitter (multimode wireless power transfer (WPT) Tx device, hereinafter referred to as “MMTx”) for supporting a multimode wireless power transmission method may also transmit power in a wireless power receiver (a single mode WPT Tx device, hereinafter referred to as “SMTx”) that is operated in any one of the electromagnetic induction mode and the electromagnetic resonance mode and a wireless power receiver (multimode WPT Rx device, hereinafter referred to as “MMRx”) for supporting a multimode wireless power transmission method may also receive power from a wireless power transmitter (a single mode WPT Rx device, hereinafter referred to as “SMRx”.) that is operated in any one of the electromagnetic induction mode and the electromagnetic resonance mode.

The MMTx for supporting the electromagnetic induction mode and the electromagnetic resonance mode may be divided into a first wireless power transmitter (hereinafter referred to as “Tier 1 MMTx”) for simultaneously supporting the above two modes and a second wireless power transmitter (hereinafter referred to as “Tier 2 MMTx”) for supporting any one mode at one time from the two modes.

The Tier 1 MMTx may simultaneously transmit power in the electromagnetic induction mode and the electromagnetic resonance mode and, to execute the two modes, the Tier 1 MMTx may perform detection procedures corresponding to the respective modes. For example, the Tier 1 MMTx may detect the MMRx or the SMRx using an analog ping of the electromagnetic induction mode and a short beacon of the electromagnetic resonance mode. The Tier 1 MMTx may insert the detection procedures corresponding to the respective modes in terms of a time sequence to perform the detection procedures.

Upon detecting presence of the SMRx (the wireless power receiver for supporting the electromagnetic induction mode or the wireless power receiver for supporting the electromagnetic resonance mode), the Tier 1 MMTx may stop communication session establishment for performing wireless power transmission corresponding to a wireless power transmission mode that is first detected after the detection procedure is stopped.

However, upon detecting presence of the MMRx for supporting both the two modes, the Tier 1 MMTx may continue to perform a detection procedure of another wireless power transmission mode other than a first detected wireless power transmission mode.

When communication session establishment for performing wireless power transmission with the SMRx or the MMTx is not completed, the Tier 1 MMTx may re-insert the detection procedures corresponding to the respective modes in terms of a time sequence to perform the detection procedures.

While the Tier 1 MMTx transmits power in any one of the wireless power transmission modes, if the Tier 2 MMRx attempts to establish a communication session for performing wireless power transmission using other wireless power transmission, the Tier 1 MMTx may terminate wireless power transmission establishment of the Tier 2 MMRx via a predefined process.

The Tier 1 MMTx may receive a multimode advertising (MMA) signal for searching for a wireless power transmitter from the MMRx or the SMRx.

The multimode advertising (MMA) signal may be used to search for a wireless power transmission transmitter/receiver that is operated in the electromagnetic induction mode and/or the electromagnetic induction mode. In other words, MMA performed by a power transmitting unit (PTU) applied to communication in electromagnetic resonance mode may use characteristics defined as an electromagnetic induction mode.

The Tier 2 MMTx may transmit power in only one of the electromagnetic induction mode and the electromagnetic resonance mode and, to execute only one of the two modes, the Tier 2 MMTx may apply a power signal to a coil to use a frequency of any one of the two modes at one time.

When the Tier 2 MMTx does not transmit power to the wireless power receiver, the Tier 2 MMTx may perform a detection procedure in the two modes. The detection procedure of the Tier 2 MMTx does not require continuous operations of the two modes and, thus, a detection procedure of each mode may be inserted at reference requirement timing and may be performed.

The Tier 2 MMTx may transmit power to a first MMTx or SMTx that completes detection and authentication procedures that are required by any one of the two modes.

While the Tier 2 MMTx transmits power in any one of the wireless power transmission modes, the Tier 2 MMTx may not attempt a detection procedure in another wireless power transmission mode.

When wireless power transmission defined in each of the two modes is completed, the Tier 2 MMTx may return to a multimode detection procedure.

The Tier 2 MMTx may also receive a multimode advertising (MMA) signal for searching for a wireless power transmitter from the MMRx or the SMRx.

The Tier 2 MMTx may include a user interface (UI) for displaying a state of a specific mode of an operation at a specific time point.

The MMRx for supporting the electromagnetic induction mode and the electromagnetic resonance mode may perform wireless power transmission with the SMTx for supporting one wireless power transmission mode as well as the MMTx that smoothly selects and executes the two wireless power transmission modes without user intervention. The MMRx may be divided into a first type wireless power receiver (hereinafter referred to as “Tier 1 MMRx”) for simultaneously supporting the two modes and a second type wireless power receiver (hereinafter referred to as “Tier 2 MMRx”) for executing any one of the two modes at one time.

The Tier 1 MMRx may provide power required for a system when at least one of the electromagnetic induction mode and the electromagnetic resonance mode is activated.

The Tier 2 MMRx may support one mode at one time and the Tier 2 MMRx may not be damaged from the wireless power transmitter as a multimode power transmission mode is executed and may not damage the wireless power transmitter as the multimode power transmission mode is executed. However, when the multimode transmission mode is executed, it may not be necessary to actively provide power to a load (system).

The MMRx may transmit may transmit information on whether power is received using one mode at one time or is received using two modes to the wireless power transmitter using communication protocols defined in respective modes during a procedure of receiving power.

When the MMRx is not currently capable of appropriately receiving power using any one of the two modes, the MMRx may not automatically transition to another mode. The MMRx may use a mechanism defined for a specific mode to generate a signal for terminating any one of the wireless power transmission modes and may use a mechanism defined to set another mode.

In this case, the wireless power transmitter may adaptively determine a wireless power transmission mode to be sued for a corresponding wireless power receiver based on a type, a state, required power, and so on of the wireless power receiver as well as a wireless power transmission mode supportable by a wireless power transmitter and a wireless power receiver.

The Tier 1 MMRx may perform two types of transition using a method “make before break” to continuously perform power transmission in the Tier 1 MMTx. When transition fails, the MMRx may continuously receive power using the same method as a method prior to transition.

The Tier 1 MMRx may communicate directly with a new wireless power transmitter to reduce a time period required for transition before access to any one wireless power transmitter using a method “make before break” is terminated.

Before another transition method using an alternate mode is set, the Tier 1 MMRx that receives power from the Tier 2 MMTx or the Tier 2 MMRx that receives power from the Tier 1 and 2 MMTx needs to terminate a session in a currently executed mode. However, when this attempt fails, the MMRx may attempt re-connection for an originally executed mode.

When a power carrier is detected only in a resonance frequency range, the MMRx may perform communication using Bluetooth low energy (BLE) defined in the electromagnetic resonance mode.

When a power carrier is detected only in an induction frequency range, the MMRx may perform communication using in band load modulation communication defined in the electromagnetic induction mode.

FIG. 10 is a flowchart for explanation of an operation of a wireless power transmitter and a wireless power receiver, for supporting a multimode wireless power transmission mode according to an embodiment of the present disclosure.

Referring to FIG. 10, an embodiment of the present disclosure relates to a transition method of a wireless power transmission mode to an electromagnetic resonance mode from an electromagnetic induction mode. A wireless power transmitter 1000 and a wireless power receiver 1050 are assumed to each be a device that operates according to the PMA standard, but the scope of the present disclosure is not limited thereto.

When power is supplied to the wireless power transmitter 1000 (S1001), the wireless power transmitter 1000 may enter a standby phase. Then, the wireless power transmitter 1000 may detect whether an object is present in an active area of an interface surface based on a current change of a transmission coil (S1002).

Upon detecting the object in the active area, the wireless power transmitter 1000 may enter a digital ping phase. The wireless power transmitter 1000 may transmit a digital ping for identifying whether the detected object is a PMA compatible receiver (S1003).

When sufficient power is supplied to a reception end of the wireless power receiver 1050 according to the digital ping transmitted by the wireless power transmitter 1000, power may be supplied to the wireless power receiver 1050 (S1004). When power is supplied to the wireless power receiver 1050, the wireless power receiver 1050 may enter the standby phase and, upon detecting a power carrier from a reception power, the wireless power receiver 1050 may enter the digital ping phase.

The digital ping may generated with a predetermined frequency and timing that are predefined according to the PMA standard and may include an advertising message including information on a type and capability (e.g., multimode capability) of the wireless power transmitter 1000. The information on the multimode capability may include information on whether the wireless power transmitter 1000 supports a multimode and information on a type of multimode transmitter (Tier 1 MMTx or Tier 2 MMTx) corresponding to the wireless power transmitter 1000.

The wireless power receiver 1050 may transmit receiver identification information in response to the received digital ping (S1006). The receiver identification information may be a unique identifier allocated to the wireless power receiver 1050 that is a PMA compatible receiver, e.g., RXID. The wireless power receiver 1050 may transmit the receiver identification information and, then, may enter an identification phase.

Upon identifying that the wireless power transmitter 1000 is a transmitter for supporting extended signaling from the advertising message of the wireless power transmitter 1000, the wireless power receiver 1050 may transmit receiver capability information (S1007). Here, the wireless power transmitter 1000 and the wireless power receiver 1050 are each assumed to a device for supporting extended signaling.

The receiver capability information may include information on capability (e.g., multimode capability) of the wireless power receiver 1050 and may be a signal transmitted in the identification phase.

The receiver capability information may be configured in a message format of Table 1 below.

TABLE 1

| | | | | |
|---|---|---|---|---|
| MSGS | Message ID | Length | PMA | CRC16 |
| | (0x01) | (1 Byte) | Capabilities | (2 Bytes) |
| | | | (N Bytes) | |

Here, MSGS may be a field indicating beginning of receiver capability information, Message ID may be a field indicating a message type, and the receiver capability information may be set to 0x01. Length may be a field indicating a length of receiver capability information that is included thereafter and may include 1 byte indicating the number of bytes except for CRC16.

PMA Capabilities may be a field including capability information of the wireless power receiver 1050 and may include an arbitrary number (N being an arbitrary positive number) of bytes. CRC16 may be a field for error detection of receiver capability information and may include 2 bytes.

The PMA Capabilities field may include induction mode support information, resonance mode support information, and simultaneous operable information and each information item may include 1 bit.

The induction mode support information may be information on whether the wireless power receiver 1050 is operable in the electromagnetic induction mode and, in this regard, when a value of the information is 0, this may indicate that the electromagnetic induction mode is not supported and, when the value of the information is 1, this may indicate that the electromagnetic induction mode is supported. Here, the wireless power receiver 1050 is a receiver according to the PMA standard and, thus, the induction mode support information may be set to 1.

The resonance mode support information may be information on whether the wireless power receiver 1050 is operable in the electromagnetic resonance mode and, in this regard, when a value of the information is 0, this may indicate that the electromagnetic resonance mode is not supported and, when the value of the information is 1, this may indicate that the electromagnetic resonance mode is supported. In the specification, the wireless power receiver 1050 is assumed to support the electromagnetic resonance mode and the resonance mode support information may be set to 1.

The simultaneous operable information may be information on whether the wireless power receiver 1050 is simultaneously operable in the electromagnetic induction mode and the electromagnetic resonance mode and, in this regard, when a value of the information is 0, this may indicate that the wireless power receiver 1050 is not simultaneously operable in the electromagnetic induction mode and the electromagnetic resonance mode and, when the value of the information is 1, this may indicate that the wireless power receiver 1050 is simultaneously operable in the electromagnetic induction mode and the electromagnetic resonance mode. That is, when both the induction mode support information and the resonance mode support information has a value of 1 and the simultaneous operable information has a value of 1, this may indicate that the wireless power receiver 1050 is the Tier 1 MMRx. In addition, when both the induction mode support information and the resonance mode support information have a value of 1 and the simultaneous operable information has a value of 0, this may indicate that the wireless power receiver 1050 is the Tier 2 MMRx.

Accordingly, the wireless power transmitter 1000 may acquire information such as information on a mode supported by the wireless power receiver 1050, i.e., an alternative mode or a type of alternative mode, from the receiver capability information.

The wireless power transmitter 1000 may enter a power transfer phase and may transmit power to the wireless power receiver 1050 when receiver identification is successful, from the receiver identification information (S1008).

The wireless power receiver 1050 may transmit receiver capability information and, then, when a predetermined guard time elapses, the wireless power receiver 1050 may transition to a power transfer phase and may receive power from the wireless power transmitter 1000. The wireless power receiver 1050 may generate power control information with a predetermined period during power reception and may transmit the power control information to the wireless power transmitter 1000 (S1009).

The power control information may information for control of a frequency of a power signal of the wireless power transmitter 1000 and, for example, when a frequency is increased, transmitted power may be reduced and, when a frequency is reduced, transmitted power may be increased.

That is, during a power transfer phase, the wireless power transmitter 1000 may adjust transmitted power according to the power control information.

When an event (e.g., end of charge, overcurrent generation, and overvoltage generation) in which charging needs to be terminated occurs during power reception, the wireless power receiver 1050 may enter an end of charge phase. The wireless power receiver 1050 that enters the end of charge phase may transmit an end of charge request and, prior to this, the wireless power receiver 1050 may transmit extended end of charge information to the wireless power transmitter 1000 (S1010).

In this case, the wireless power receiver 1050 may transmit the extended end of charge information only when the wireless power transmitter 1000 supports extended signaling.

The extended end of charge information may be configured in a message format of Table 2 below.

TABLE 2

| | | | | |
|---|---|---|---|---|
| MSGS | Message ID | PMA EOP | Tx Sleep | CRC8 |
| | (0x41) | Reason | (1 Nibble) | (1 Byte) |
| | | (1 Nibble) | | |

Here, MSGS may be a field indicating beginning of extended end of charge information, Message ID may be a field indicating a message type, and the extended end of charge information may be set to 0x41.

PMA EOP Reason may be a field indicating the reason for transmitting the end of charge request and may include 1 nibble. PMA EOP Reason is described below in detail with reference to Table 3 below.

Tx sleep may be a field indicating a time period required for standby by the wireless power transmitter 1000 when the end of charge request is received and, then, a power carrier is removed and may include 1 nibble. Tx sleep is described below in detail with reference to Table 4 below.

CRC8 may be a field for error detection of the extended end of charge information and may include 1 byte.

PMA EOP Reason may include a code value and information corresponding thereto as shown in Table 3 below.

TABLE 3

| EOP | | |
|---|---|---|
| Reason | | |
| Code | Reason | Description |
| 0x0 | Battery Fully | Normal PMA EOP state, which is started |
| | Charged | when current is equal to or less than |
| | | predetermined threshold value for |
| | | predetermined period |
| 0x1 | No Load | Detect load disconnection |
| 0x2 | Host PMA EOP | Charging end requested by host (Embody |
| | Request | incase HCI) |
| 0x3 | Incompatible | Transmitter and receiver are incompatible |
| | Power Class | |
| 0x4 | Over | Error state with over temperature detected |
| | Temperature | |
| 0x5 | Overvoltage | Error state with overvoltage detected by |
| | | receiver |
| 0x6 | Overcurrent | Error state with overcurrent detected by |
| | | receiver |
| 0x7 | Over PMA DEC | Error state with over PMA DEC detected |
| 0x8 | Alternate | When alternate power source with high |
| | Supply | priority, such as wired adaptor, is |
| | Connected | connected |
| 0x9 | Internal Fault | Detect internal fault that is not |
| | | predetermined in receiver circuit |
| 0xA | Voltage | When receiver voltage of receiver is not |
| | Stabilization | stabled within required level to exceed |
| | Error | defined limited time |
| 0xB | Communication | Detect unsolvable communication error in |
| | Error | communication protocol |
| 0xC | Reconfigure | When receiver intends to reset connection |
| | | and initiates reconfiguration |
| 0XD-0xF | TBD | Reserved for future setting |

Code value 0x0 of PMA EOP Reason refers to Battery fully charged and is generated when charging of an electronic device is completed and output current is maintained to be a predetermined threshold value or less for a predetermined period.

A code value 0x1 of PMA EOP Reason refers to No load and is generated when load disconnection is detected.

A code value 0x2 of PMA EOP Reason refers to Host PMA EOP request and is generated when a signal for making a request to a host (e.g., an electronic device) for end of charging is received.

A code value 0x3 of PMA EOP Reason refers to Incompatible power class and is generated when a power class of a transmitter and a power class of a receiver are incompatible and power transmission is determined to be inappropriate.

A code value 0x4 of PMA EOP Reason refers to Over temperature and is generated when over temperature is detected.

A code value 0x5 of PMA EOP Reason refers to Overvoltage and is generated when overvoltage is detected.

A code value 0x6 of PMA EOP Reason refers to Overcurrent and is generated when overcurrent is detected.

A code value 0x7 of PMA EOP Reason refers to Over PMA DEC and is generated when a signal for making a request for reduction in transmitted power transmitted to a transmitter side is excessively generated.

A code value 0x8 of PMA EOP Reason refers to alternate supply connected and is generated when an alternate power source with high priority, such as a wired power adaptor, is connected.

A code value 0x9 of PMA EOP Reason refers to Internal Fault and is generated when internal fault that is not predetermined is detected in a receiver circuit.

A code value 0xA of PMA EOP Reason refers to Voltage stabilization error and is generated when a receiver voltage (e.g., a rectifier voltage) is not stabilized within a predetermined range to exceed a defined limited time (e.g., greater than 500 ms).

A code value 0xB of PMA EOP Reason refers to Communication Error and is generated when unsolvable communication error is detected.

A code value 0xC of PMA EOP Reason refers to reconfigure and is generated when connection with a transmitter needs to be reset and reconfigured.

In addition, any one of code values 0xD to 0xF of PMA EOP Reason refers to mode transition and is generated when a request for transition from a specific operation mode (e.g., an operation according to an electromagnetic induction mode) to another operation mode (e.g., an operation according to an electromagnetic resonance mode) is made to a transmitter.

The Tx sleep may include a code value and information corresponding thereto as shown in Table 4 below.

TABLE 4

| Tx sleep code | Required Tx sleep time | |
|---|---|---|
| 0x0 | 2 | seconds |
| 0x1 | 4 | seconds |
| 0x2 | 8 | seconds |
| 0x3 | 15 | seconds |
| 0x4 | 30 | seconds |
| 0x5 | 1 | minute |
| 0x6 | 2 | minutes |
| 0x7 | 4 | minutes |
| 0x8 | 8 | minutes |
| 0x9 | 15 | minutes |
| 0xA | 30 | minutes |
| 0xB | 1 | hour |
| 0xC | 2 | hours |
| 0xD | 4 | hours |

| | |
|---|---|
| 0xE | Standby until temperature |
| | reduces by 5 degrees |
| 0xF | Standby indefinitely (restart |
| | only after receiver is removed |
| | and rearranged) |

Code values 0x0 to 0xD of Tx sleep refer to time periods corresponding to a required time period for which the wireless power transmitter 1000 is on standby upon receiving an end of charge request and, then, removing a power carrier.

A code value 0xE of Tx sleep refers to a request for standby until temperature of the wireless power transmitter 1000 reduces by 5 degrees when the wireless power transmitter 1000 removes a power carrier after receiving an end of charge request.

A code value 0xF of Tx sleep refers to a request for standby indefinitely when the wireless power transmitter 1000 removes a power carrier after receiving an end of charge request.

The wireless power receiver 1050 in the end of charge phase may transmit the extended end of charge information and, then, may transmit the end of charge request to the wireless power transmitter 1000 (S1011). In this case, transmission (S1010) of the extended end of charge information and transmission (S1011) of the end of charge request may be periodically and alternately interleaved and performed.

Upon determining that a power transmission mode is capable of transitioning and is required, the wireless power receiver 1050 may make a request to the wireless power transmitter 1000 for transition of a power transmission mode using the extended end of charge information.

That is, the wireless power receiver 1050 in the alternative mode may determine that the wireless power transmitter 1000 is capable of transitioning a power transmission mode as a multimode transmitter through information on multimode capability, included in the advertising message of the wireless power transmitter 1000.

The wireless power receiver 1050 may determine that a power transmission mode needs to transition when voltage stabilization error, i.e., error whereby a voltage (e.g., rectifier voltage) of the wireless power receiver 1050 is not stabilized within a predetermined range is maintained to exceed a predetermined time (e.g., 200 ms is exceeded). This is merely an embodiment of determining that a power transmission needs to transition and the scope of the present disclosure is not limited thereto.

That is, according to another embodiment, when current (e.g., rectifier current) of the wireless power receiver 1050 is equal to or less than minimum current (e.g., 1.05 times of a minimum threshold Icc), the wireless power receiver 1050 may determine that a power transmission mode needs to transition.

According to another embodiment, the wireless power transmitter 1000 or the wireless power receiver 1050 may calculate current power transmission efficiency (a reception power ratio at a receiver side to transmission power at a transmitter side) and, when power transmission efficiency is equal to or less than a specific threshold value, the wireless power receiver 1050 that recognizes this may determine that a power transmission mode needs to transition.

According to an embodiment, the wireless power receiver 1050 may set PMA EOP Reason of the extended end of charge information to a specific code (e.g., 0xA) and may set Tx sleep to a specific time (e.g., 5 sec) or less (0x0 or 0x1) to make a request to the wireless power transmitter 1000 for transition of a power transmission mode. That is, a request for transition of a power transmission when PMA EOP Reason is a specific code (e.g., 0xA) and Tx sleep is set to a specific time or less may be predetermined between the wireless power transmitter 1000 and the wireless power receiver 1050. Needless to say, even if PMA EOP Reason is a specific code (e.g., 0xA), a non-request of transition of a power transmission mode when Tx sleep is not set to a specific time or less may be predetermined between the wireless power transmitter 1000 and the wireless power receiver 1050.

According to another embodiment, the wireless power receiver 1050 may make a request to the wireless power transmitter 1000 for transition of a power transmission mode using any one of code values 0xD to 0xF of PMA EOP Reason, which is predetermined as a code for request for transition of a power transmission mode between the wireless power transmitter 1000 and the wireless power receiver 1050.

According to another embodiment, the wireless power receiver 1050 may set PMA EOP Reason to 0xA to make a request to the wireless power transmitter 1000 for transition of a power transmission mode irrespective of Tx sleep. That is, request for transition of a power transmissions mode by the wireless power receiver 1050 when the PMA EOP Reason is voltage stabilization error may be predetermined between the wireless power transmitter 1000 and the wireless power receiver 1050.

According to another embodiment, the wireless power receiver 1050 may set Tx sleep to a specific time (e.g., 5 sec) or less irrespective of PMA EOP Reason (0x0 or 0x1) and, thus, may make a request to the wireless power transmitter 1000 for transition of a power transmission mode. That is, a request for transition of a power transmission by the wireless power receiver 1050 when the Tx sleep is set to a specific time or less may be predetermined between the wireless power transmitter 1000 and the wireless power receiver 1050.

That is, through a specific code value of PMA EOP Reason or Tx sleep of the extended end of charge information or a combination of specific code values of PMA EOP Reason and Tx sleep (in other words, through at least one of PMA EOP Reason and Tx sleep of the extended end of charge information), the wireless power receiver 1050 may make a request to the wireless power transmitter 1000 for transition of a power transmission mode.

According to each of the above embodiments, Tx sleep refers to a mode transition time as a reference time in which a power transmission mode needs to completely transition.

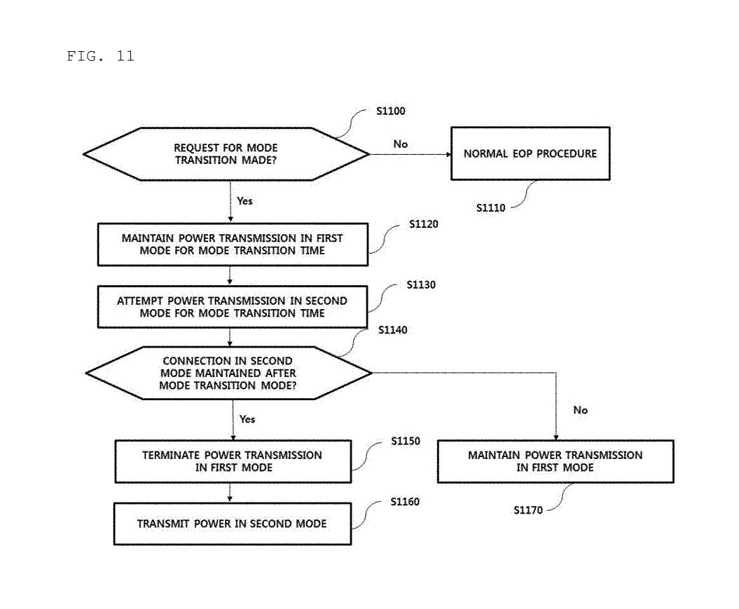

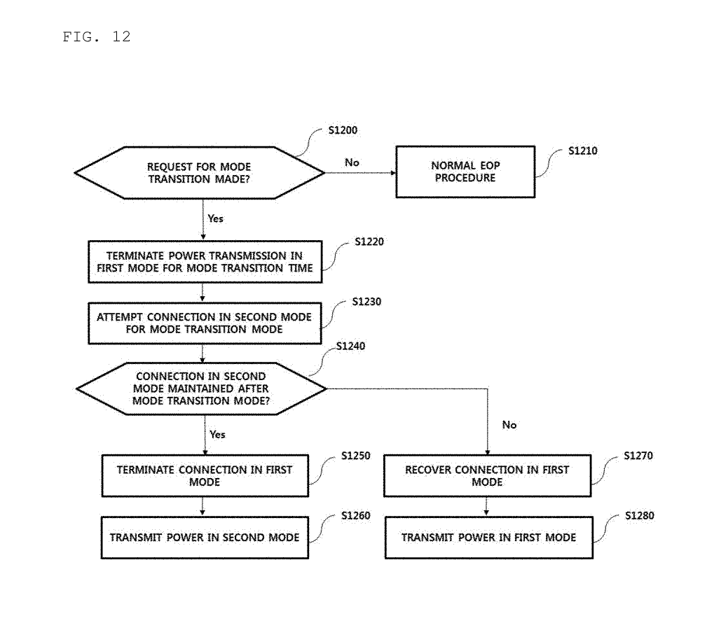

The wireless power transmitter 1000 that receives the end of charge request may enter the end of charge phase and may immediately perform an operation according to a mode transition algorithm (S1012). A mode transition algorithm may be an algorithm of determining whether a power transmission mode of the wireless power transmitter 1000 transitions according to whether the end of charge request and the extended end of charge information are received and performing an operation according to the determination result and is described below with reference to FIGS. 11 and 12.

FIG. 11 is a flowchart for explanation of a mode transition algorithm according to an embodiment.

Referring to FIG. 11, the algorithm shown in FIG. 11 may be a mode transition algorithm when the wireless power transmitter 1000 and the wireless power receiver 1050 are Tier 1 MMTx and Tier 1 MMRx, respectively, i.e., when the wireless power transmitter 1000 and the wireless power receiver 1050 are each a device that is capable of simultaneously transmitting and receiving power in the electromagnetic induction mode and the electromagnetic resonance mode.

The wireless power transmitter 1000 may receive the end of charge request and, then, may determine whether a request for transition of a power transmission mode is made, based on the extended end of charge information (S1100). That is, whether a specific code value of PMA EOP Reason or Tx sleep of the extended end of charge information described above with reference to FIG. 10, or a combination of specific code values of PMA EOP Reason and Tx sleep is used for a request for transition of a power transmission mode is made may be determined.

When the request for transition of a power transmission mode is not made (No of S1100), a normal end of charge (EOP) procedure may be performed (S1110). The normal EOP procedure has been described above with reference to FIG. 7 and, thus, a repeated description thereof is omitted.

When the request for transition of a power transmission mode is made (Yes of S1100), the wireless power transmitter 1000 may maintain power transmission of a first mode for a mode transition time determined according to Tx sleep (S1120). The first mode refers to an electromagnetic induction mode in which the wireless power transmitter 1000 currently transmits power.

This is because continuity of power transmission needs to be ensured even for a mode transition time because the wireless power transmitter 1000 and the wireless power receiver 1050 are devices for simultaneously transmitting and receiving power in an electromagnetic induction mode and an electromagnetic resonance mode.

The wireless power transmitter 1000 may attempt connection with the wireless power receiver 1050 in a second mode for a mode transition time (S1130). The second mode refers to an electromagnetic resonance mode in which the wireless power transmitter 1000 currently attempts mode transition.

Here, the attempt of connection with the wireless power receiver 1050 refers to performing of an out-of-band communication link establishment procedure or registration procedure through the configuration state 910, the power save state 920, and the low power state 930 which are described with reference to FIG. 9.

When the mode transition time elapses, the wireless power transmitter 1000 may determine whether connection with the wireless power receiver 1050 in a second mode is maintained (S1140). For example, data transmission and reception with the wireless power receiver 1050 is normally performed through an out-of-band communication link, the wireless power transmitter 1000 may determine that connection with the wireless power receiver 1050 in the second mode is maintained.

When connection with the wireless power receiver 1050 in the second mode is maintained (Yes of S1140), the current state is a state in which power is capable of being transmitted in the second mode and, thus, the wireless power transmitter 1000 may terminate power transmission in the first mode (S1150). That is, the main controller 230 of FIG. may control a mode selection switch 240 to block power supplied to an induction transmitter 210.

The wireless power transmitter 1000 may transmit power to the wireless power receiver 1050 in the second mode (S1160). That is, the wireless power transmitter 1000 may complete an operation in the low power state 930 and may transition to the power transfer state 940 to transmit power to the wireless power receiver 1050.

When connection with the wireless power receiver 1050 in the second mode is not maintained (No of S1140), the current state is a state in which power is not capable of being transmitted in the second mode and, thus, the wireless power transmitter 1000 may terminate an operation of the wireless power transmitter 1000 in the second mode and may maintain power transmission in the first mode (S1170).

In this case, the wireless power receiver 1050 may also transmit power reception and power control information to the wireless power transmitter 1000 in the first mode during the mode transition time and may also normally operate to transmit and receive power in the first mode after a mode transition time elapses.

According to an embodiment, when a problem occurs in that efficiency is not good or unstable during power transmission in the electromagnetic induction mode by a wireless power transmitter or a wireless power receiver that supports both the electromagnetic resonance mode and the electromagnetic induction mode, power transmission in the electromagnetic induction mode may be attempted to enhance power transmissions and reception efficiency of the wireless power transmitter and the wireless power receiver.

FIG. 12 is a flowchart for explanation of a mode transition algorithm according to another embodiment of the present disclosure.

Referring to FIG. 12, the algorithm shown in FIG. 12 corresponds to a mode transition algorithm when the wireless power transmitter 1000 and the wireless power receiver 1050 are the Tier 1 MMTx and the Tier 2 MMRx, the Tier 2 MMTx and the Tier 1 MMRx, or the Tier 2 MMTx and the Tier 2 MMRx, respectively, that is, when at least one of the wireless power transmitter 1000 and the wireless power receiver 1050 is not a device that simultaneously transmits and receives power in the electromagnetic induction mode and the electromagnetic resonance mode.

The wireless power transmitter 1000 may receive the end of charge request and, then, may determine whether a request for transition of a power transmission mode is made based on the extended end of charge information (S1200). That is, whether a specific code value of PMA EOP Reason or Tx sleep of the extended end of charge information described above with reference to FIG. 10, or a combination of specific code values of PMA EOP Reason and Tx sleep is used for a request for transition of a power transmission mode is made may be determined.

When the request for transition of a power transmission mode is not made (No of S1200), a normal end of charge (EOP) procedure may be performed (S1210). The normal EOP procedure has been described above with reference to FIG. 7 and, thus, a repeated description thereof is omitted.

When the request for transition of a power transmission mode is made (Yes of S1200), the wireless power transmitter 1000 may maintain power transmission of a first mode for a mode transition time determined according to Tx sleep (S1120). The first mode refers to an electromagnetic induction mode in which the wireless power transmitter 1000 currently transmits power.

This is because power transmission in a current mode needs to be stopped to transmit power in another mode (when the wireless power receiver 1050 is not capable of simultaneously transmitting in two modes) or to protect the wireless power receiver 1050 (when the wireless power receiver 1050 is not capable of simultaneously receiving power in two modes) because at least one of the wireless power transmitter 1000 and the wireless power receiver 1050 is a device that is not capable of simultaneously transmitting and receiving in an electromagnetic induction mode and an electromagnetic resonance mode).

Here, termination of power transmission in the first mode may refer to the case in which a state based on the first mode of the wireless power transmitter 1000 enters the standby phase 710 of FIG. 7.

The wireless power transmitter 1000 may attempt connection with the wireless power receiver 1050 in the second mode during a mode transition time (S1230). The second mode may refer to an electromagnetic resonance mode in which the wireless power transmitter 1000 currently attempts mode transition.

Here, attempt of connection with the wireless power receiver 1050 refers to performing of an out-of-band communication link establishment procedure or registration procedure through the configuration state 910, the power save state 920, and the low power state 930 which are described with reference to FIG. 9.

When the mode transition time elapses, the wireless power transmitter 1000 may determine whether connection with the wireless power receiver 1050 in a second mode is maintained (S1240). For example, data transmission and reception with the wireless power receiver 1050 is normally performed through an out-of-band communication link, the wireless power transmitter 1000 may determine that connection with the wireless power receiver 1050 in the second mode is maintained.

When connection with the wireless power receiver 1050 in the second mode is maintained (Yes of S1240), the current state is a state in which power is capable of being transmitted in the second mode and, thus, the wireless power transmitter 1000 may terminate power transmission in the first mode (S1250). That is, the main controller 230 of FIG. 2 may control the mode selection switch 240 to block power supplied to an induction transmitter 210.

The wireless power transmitter 1000 may transmit power to the wireless power receiver 1050 in the second mode (S1260). That is, the wireless power transmitter 1000 may complete an operation in the low power state 930 and may transition to the power transfer state 940 to transmit power to the wireless power receiver 1050.

When connection with the wireless power receiver 1050 in the second mode is not maintained (No of S1240), the current state is a state in which power is not capable of being transmitted in the second mode and, thus, the wireless power transmitter 1000 may terminate an operation of the wireless power transmitter 1000 in the second mode and may recover power transmission in the first mode (S1270).

In this case, the wireless power receiver 1050 may receive a digital ping of the wireless power transmitter 1000 and may transmit receiver identification information and the wireless power transmitter 1000 may identify that the wireless power receiver 1050 is a device that has make a request for mode transition during pre-reception of power in the first mode, from the receiver identification information. In this case, the wireless power transmitter 1000 and the wireless power receiver 1050 may omit other identification procedures and may immediately transition to a power transfer phase. To this end, the wireless power transmitter 1000 may store various information items (receiver identification information, receiver capability information, etc.) of the wireless power receiver 1050. Accordingly, when mode transition fails, previous power transmission in a power transfer mode may be rapidly performed if possible and, thus, power transmission efficiency may be prevented from being degraded due to attempt of mode transition.

Such recovery of connection in the first mode may be defined as a fast recovery procedure.

When connection in the first mode is recovered, the wireless power transmitter 1000 and the wireless power receiver 1050 may perform power transmission in the first mode (S1280).

In the specification, although the embodiments have been described in terms of the case in which a power control method according to an embodiment is applied to a wireless power transmitter or a wireless power receiver according to the PMA standard, the scope of the present disclosure is not limited thereto and, thus, it would be obvious that substantially the same technical features are applicable through the same or corresponding information as information used in a wireless power transmitter or a wireless power receiver according to other standards such as the WPC standard.

The method according to the aforementioned embodiment may be prepared in a program to be executable in a computer and may be stored in a computer readable recording medium. Examples of the computer readable recording medium include read-only memory (ROM), random-access memory (RAM), CD-ROMs, magnetic tapes, floppy disks, optical data storage devices, etc. and may be realized in the form of a carrier wave (for example, transmission over the Internet).

The computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

Those skilled in the art will appreciate that the present disclosure may be carried out in other specific ways than those set forth herein without departing from the spirit and essential characteristics of the present disclosure.

It will be apparent to those skilled in the art that various modifications and variations can be made in the present disclosure without departing from the spirit or scope of the present disclosure. Thus, it is intended that the present disclosure cover the modifications and variations of the embodiment provided they come within the scope of the appended claims and their equivalents.

### INDUSTRIAL APPLICABILITY

The present disclosure relates to wireless charging technology and may be applied to a wireless power transmission apparatus for wirelessly transmitting power.

1. An operation method of a wireless power receiver, the method comprising:
determining whether a power transfer mode needs transition during wireless charging in an electromagnetic induction mode;
making a request to a wireless power transmitter for transition of the power transfer mode using extended end of charge information when the power transfer mode needs to transition; and
receiving power in a power transfer mode that is determined according to whether the wireless power transmitter is connected in an electromagnetic resonance mode.

2. The method of claim 1, wherein the determining of whether the power transfer mode needs to transition includes determining whether error whereby a voltage of the wireless power receiver is not stabilized within a predetermined range is maintained to exceed a predetermined time.

3. The method of claim 1, wherein the determining of whether the power transfer mode needs to transition includes determining whether current of the wireless power receiver is equal to or less than minimum current.

4. The method of claim 1, wherein the determining of whether the power transfer mode needs to transition includes determining whether power transmission efficiency between the wireless power transmitter and the wireless power receiver is equal to or less than a threshold value.

5. The method of claim 1, wherein the making a request for transition of the power transfer mode includes making a request to the wireless power transmitter for transition of the power transfer mode through at least one of EOP Reason and Tx sleep of the extended end of charge information.

6. The method of claim 1, wherein:
the making a request for transition of the power transfer mode includes setting the PMA EOP Reason of the extended end of charge information to a specific code; and
the specific code is voltage stabilization error or mode transition.

7. The method of claim 1, wherein:
the making a request for transition of the power transfer mode includes setting the Tx sleep of the extended end of charge information to a specific time or less; and
the Tx sleep is a reference time for completing transition of the power transfer mode.

8. An operation method of a wireless power transmitter, the method comprising:
receiving extended end of charge information from a wireless power receiver during wireless charging in an electromagnetic induction mode;
determining whether the wireless power receiver makes a request for transition of a power transfer mode using the extended end of charge information; and
upon making a request for transition of the power transfer mode, transmitting power in a power transfer mode that is determined according to whether the wireless power transmitter is connected in an electromagnetic resonance mode.

9. The method of claim 8, wherein the determining of whether the wireless power receiver makes a request for transition includes determining whether the wireless power receiver makes a request for transition of the power transfer mode using at least one of PMA EOP Reason and Tx sleep of the extended end of charge information.

10. The method of claim 8, wherein:
the determining of whether the wireless power receiver makes a request for transition includes determining whether PMA EOP Reason of the extended end of charge information is set to a specific code; and
the specific code is voltage stabilization error or mode transition.

11. The method of claim 8, wherein:
the determining of whether the wireless power receiver makes a request for transition includes determining whether the Tx sleep of the extended end of charge information is set to a specific time or less; and
the Tx sleep is a reference time for completing transition of the power transfer mode.

12. The method of claim 8, further comprising maintaining power transmission in the electromagnetic induction mode for a mode transition time when the request for transition of the power transfer mode is made and when the wireless power transmitter and the wireless power receiver are a device for simultaneously transmitting and receiving power in the electromagnetic induction mode and the electromagnetic resonance mode.

13. The method of claim 8, further comprising stopping power transmission in the electromagnetic induction mode for a mode transition time when the request for transition of the power transfer mode is made and when at least one of the wireless power transmitter and the wireless power receiver is a device that is not capable of simultaneously transmitting and receiving power in the electromagnetic induction mode and the electromagnetic resonance mode.

14. The method of claim 8, wherein the transmitting of power in the power transfer mode that is determined according to whether the wireless power transmitter is connected in the electromagnetic resonance mode includes:
attempting connection with the wireless power receiver in the electromagnetic resonance mode during a mode transition time;
determining whether connection with the wireless power receiver in the electromagnetic resonance mode is maintained after the mode transition time elapses;
terminating power transmission in the electromagnetic induction mode and performing power transmission in the electromagnetic resonance mode when connection with the wireless power receiver in the electromagnetic resonance mode is maintained; and
performing power transmission in the electromagnetic induction mode when connection with the wireless power receiver in the electromagnetic resonance mode is not maintained.

15. The method of claim 14, wherein the performing of power transmission in the electromagnetic induction mode includes:
maintaining power transmission in the electromagnetic induction mode when the wireless power transmitter and the wireless power receiver are a device that is capable of simultaneously transmitting and receiving power in the electromagnetic induction mode and the electromagnetic resonance mode; or
performing a fast recovery procedure using receiver identification information of the wireless power receiver when at least one of the wireless power transmitter and the wireless power receiver is a device that is not capable of simultaneously transmitting and receiving power in the electromagnetic induction mode and the electromagnetic resonance mode.
